(19) United States
(12) Patent Application Publication
(10) Pub. No.: US 2024/0331375 A1
(43) Pub. Date: Oct. 3, 2024

(54) SYSTEMS FOR MULTICLASS OBJECT DETECTION AND ALERTING AND METHODS THEREFOR

(71) Applicant: PERCIPIENT.AI INC., Santa Clara, CA (US)

(72) Inventors: Atul KANAUJIA, Santa Clara, CA (US); Ivan KOVTUN, Santa Clara, CA (US); Vasudev PARAMESWARAN, Santa Clara, CA (US); Timo PYLVAENAEINEN, Santa Clara, CA (US); Jerome BERCLAZ, Santa Clara, CA (US); Kunal KOTHARI, Santa Clara, CA (US); Alison HIGUERA, Santa Clara, CA (US); Winber XU, Santa Clara, CA (US); Rajendra SHAH, Santa Clara, CA (US); Balan AYYAR, Santa Clara, CA (US)

(73) Assignee: PERCIPIENT.AI INC., Santa Clara, CA (US)

(21) Appl. No.: 17/866,389

(22) PCT Filed: Jan. 19, 2021
(86) PCT No.: PCT/US2021/013932

§ 371 Date: Jul. 15, 2022

Related U.S. Application Data
(60) Provisional application No. 62/962,929, filed on Jan. 17, 2020.
(60) Provisional application No. 62/962,928, filed on Jan. 17, 2020.
(60) Provisional application No. 63/072,934, filed on Aug. 31, 2020.

(51) Int. Cl. G06V 20/13; G06T 7/73; G06V 10/82

(52) U.S. Cl. CPC G06V 20/13; G06T 7/74; G06V 10/82; G06V 2201/08

(57) ABSTRACT

Systems, methods and techniques for detecting, identifying and classifying objects, including multiple classes of objects, from satellite or terrestrial imagery where the objects of interest may be of low resolution. Includes techniques, systems and methods for alerting a user to changes in the detected objects, together with a user interface that permits a user to rapidly understand the data presented while providing the ability to easily and quickly obtain more granular supporting data.

### RELATED APPLICATIONS

This application is a continuation-in-part of U.S. patent application Ser. No. 16/120,128 filed Aug. 31, 2018, which in turn is a conversion of U.S. Patent Application Ser. No. 62/553,725 filed Sep. 1, 2017. Further, this application is a continuation-in-part of PCT applications PCT/US21/13932 and PCT/US21/13940, both filed Jan. 19, 2021, both of which are in turn conversions of U.S. Patent Application Ser. No. 62/962,928 filed Jan. 17, 2020, U.S. Patent Application Ser. No. 62/962,929 filed Jan. 17, 2020 and also U.S. Patent Application Ser. No. 63/072,934, filed Aug. 31, 2020. Further, this application claims the benefit of U.S. Patent Application 63/329,327, filed Apr. 8, 2022, and U.S. Patent Application 63/337,595, filed May 2, 2022. The present application claims the benefit of each of the foregoing, all of which are incorporated herein by reference.

### FIELD OF THE INVENTION

The present invention relates generally to detection, classification and identification of multiple types of objects captured by geospatial or other imagery, and more particularly relates to multiclass vehicle detection, classification and identification using geospatial or other imagery including identification and development of areas of interest, geofencing of same, developing a baseline image for selected areas of interest, and automatically alerting users to changes in the areas of interest.

### BACKGROUND OF THE INVENTION

Earth observation imagery has been used for numerous purposes for many years. Early images were taken from various balloons, while later images were taken from sub-orbital flights. A V-2 flight in 1946 reached an apogee of 65 miles. The first orbital satellite images of earth were made in 1959 by the Explorer 6. The famous “Blue Marble” photograph of earth was taken from space in 1972. In that same year the Landsat program began with its purpose of acquiring imagery of earth from space, and the most recent such satellite was launched in 2013. The first real-time satellite imagery became available in 1977.

Four decades and more than one hundred satellites later, earth observation imagery, typically from sources such as satellites, drones, high altitude aircraft, and balloons has been used in countless contexts for commercial, humanitarian, academic, and personal reasons. Satellite and other geospatial images have been used in meteorology, oceanography, fishing, agriculture, biodiversity, conservation, forestry, landscape, geology, cartography, regional planning, education, intelligence and warfare, often using real-time or near real-time imagery. Elevation maps, typically produced by radar or Lidar, provide a form of terrestrial earth observation imagery complementary to satellite imagery. Depending upon the type of sensor, images can be captured in the visible spectrum as well as in other spectra, for example infrared for thermal imaging, and may also be multispectral.

Sensor resolution of earth observation imagery can be characterized in several ways. Two common characteristics are radiometric resolution and geometric resolution. Radiometric resolution can be thought of as the ability of an imaging system to record many levels of brightness (contrast for example) at the effective bit-depth of the sensor. Bit depth defines the number of grayscale levels the sensor can record, and is typically expressed as 8-bit (2\hat{ }8 or 256 levels), 12-bit (2\hat{ }12) on up to 16-bit (2\hat{ }16) or higher for extremely high resolution images. Geometric resolution refers to the satellite sensor's ability to effectively image a portion of the earth's surface in a single pixel of that sensor, typically expressed in terms of Ground Sample Distance, or GSD. For example, the GSD of Landsat is approximately thirty meters, which means the smallest unit that maps to a single pixel within an image is approximately 30 m×30 m. More recent satellites achieve much higher geometric resolution, expressed as smaller GSD's. Numerous modern satellites have GSD's of less than one meter, in some cases substantially less, for example 30 centimeters. Both characteristics impact the quality of the image. For example, a panchromatic satellite image can be 12-bit single channel pixels, recorded at a given Ground Sampling Distance. A corresponding multispectral image can be 8-bit 3-channel pixels at a significantly higher GSD, which translates to lower resolution. Pansharpening, achieved by combining a panchromatic image with a multispectral image, can yield a color image that also has a low GSD, or higher resolution. In many applications, to be useful, object detection, particularly the detection and classification of mobile objects such as vehicles in a parking lot of a business, vehicles involved in rain forest deforestation and the resulting terrain changes, various types of vessels in shipping lanes or harbors, or even people or animals, needs to be accurate over a range of variations in image appearance so that downstream analytics can use the identified objects to predict financial or other performance.

FIG. 1 [Prior Art] illustrates a convolutional neural network typical of the prior art. Such convolutional neural networks are used to improve various characteristics of the incoming image, such as increasing clarity or texture, edge detection, sharpening, decreasing haze, adjusting contrast, adding blur, unsharp masking, eliminating artifacts, and so on. The processing of a digital image to effect one of the foregoing operations is sometimes referred to as feature extraction. Thus, an analog image 5 depicts how the human eye would see a scene that is captured digitally. Although the scene 5 is shown as captured in black and white to comply with Patent Office requirements, the actual image is, in many if not most instances, captured as a color image. A typical approach for digital sensors recording color images is to capture the image in layers, for example red, green and blue. Thus, the image 5 would, in a digital system, be captured as layers 10R, 10G and 10B. In many approaches, each of those layers is then processed separately, although in some approaches a 3D kernel is used such that all three layers are processed into a single set of output values. In some convolutional network solutions, each layer of the image 5 is processed by dividing the layer into a series of tiles, such that a tile 15 in the analog image becomes tile 15′ in the red layer of the digital image, and a similar tile in each of the blue and green layer. That tile comprises a plurality of pixels, usually of different values, as indicated at 15′ in the lower portion of FIG. 1. Convolution is performed on each pixel, i.e., a source pixel 20, through the use of a convolution kernel 25 to yield a destination pixel 30 in an output tile 35. The convolution process takes into account the values of the pixels surrounding the source pixel, where the values, or weights, of the convolution kernel can be varied depending upon which characteristic of the image is to be modified by the processing. The output tile then forms a portion of the output image of that stage, shown at 40A-40C.

To minimize memory and processing requirements, among other benefits, following convolution a technique referred to as “pooling” is used in some prior art approaches where clusters of pixels strongly manifest a particular characteristic or feature. Pooling minimizes processing by identifying tiles where a particular feature appears so strongly that it outweighs the values of the other pixels. In such instances, a group of tiles can be quickly reduced to a single tile. For example, tile 45 can be seen to be a square comprising four groups of 2×2 pixels each. It can be seen that the maximum value of the upper left 2×2 is 6, the maximum value of the upper right 2×2 is 8, left left max is 3 and lower right max is 4. Using pooling, a new 2×2 is formed at 50, and that cell is supplied to the output of that stage as part of matrix 40A. Layers 40B and 40C receive similar output tiles for those clusters of pixels where pooling is appropriate. The convolution and pooling steps that process layers 10R-G-B to become layers 40A-40C can be repeated, typically using different weighting in the convolution kernel to achieve different or enhanced feature extraction. Depending upon the design of that stage of the network, the matrices 40A-40C can map to a greater number, such as shown at 55A-55n. Thus, tile 55 is processed to become tile 60 in layer 55A, and, if a still further layer exists, tile 65 in layer 55A is processed and supplied to that next layer.

While conventional imaging systems can perform many useful tasks, they are generally unable to perform effective detection, classification and identification of objects for a variety of reasons. First, appearance of an object in an image can vary significantly with time of day, season, shadows, reflections, snow, rainwater on the ground, terrain, and other factors. Objects typically occupy a very small number of pixels relative to the overall image. For example, if the objects of interest are vehicles, at a GSD of 30 centimeters a vehicle will typically occupy about 6×15 pixels in an image of 16 K×16 K pixels. To give a sense of scale, that 16 K×16 K image typically covers 25 square kilometers. At that resolution, prior art approaches have difficulty to distinguish between vehicles and other structures on the ground such as small buildings, sheds or even signage. Training a prior art image processing system to achieve the necessary accuracy despite the variation of appearances of the objects is typically a long and tedious process.

The challenges faced by the prior art become more numerous and complex if multiple classes of objects are being detected. Using vehicles again as a convenient example, and particularly multiple classes of vehicles such as sedans, trucks, SUV, minivans, and buses or other large vehicles, detection, classification and identification of such vehicles by the imaging system requires periodic retraining especially as the number of types of vehicles grows over time. Such vehicle-related systems are sometimes referred to as Multiclass Vehicle Detection (MVD) systems. In the prior art, the retraining process for such systems is laborious and time-consuming.

Many conventional image processing platforms attempt to perform multiclass vehicle detection by inputting images to a deep neural network (DNN) trained using conventional training processes. Other conventional systems have attempted to improve the precision and recall of MVD systems using techniques including focal loss, reduced focal loss, and ensemble networks. However, these and other existing methods are incapable of detecting new classes of vehicles that were not labeled in the initial training dataset used to train the MVD.

Furthermore, most conventional approaches use object detection neural networks that were originally designed for terrestrial imagery. Such approaches do not account for the unique challenges presented by satellite imagery, nor appreciate the opportunities such imagery offers. While perspective distortions are absent in satellite imagery, analysis of satellite imagery requires compensating for translation and rotation variance. Additionally, such prior art neural networks need to account for image distortions caused by atmospheric effects when evaluating the very few pixels in a satellite image that may represent any of a variety of types of vehicles, including changes in their position and orientation.

In addition to the aforesaid shortcomings of prior art systems in detecting, classifying and identifying objects within a geographical area of interest, such systems have likewise struggled to automatically identify for a user, within a reasonable level of assurance, whether the number, types, positions or orientations of the objects have changed since the last image of the region was captured.

Thus, there has been a long-felt need for a platform, system and method for substantially automatically detecting, classifying and identifying objects of various types within an area of interest.

Further, there has also been a long-felt need for a platform, system and method for substantially automatically detecting changes in type, number, location and orientation of one or more types of objects within a defined field of view.

### SUMMARY OF THE INVENTION

The present invention overcomes the limitations of the prior art by providing a system, platform and method capable of rapidly and accurately detecting, classifying and identifying any or all of a plurality of types of objects in a satellite or terrestrial image. Depending upon the embodiment, images are processed through various techniques including embedding, deep learning, and so on, or combinations of these techniques, to detect, identify and classify various types of objects in the image. The processing of the initial image provides baseline data that characterizes the objects in the image. In an embodiment, that baseline data is used to generate a report for review by a user and the process ends. In a further embodiment a second image of the same general geofenced area as the first area is provided for processing. In such an embodiment, the present invention processes the second image to be spatially congruent with the baseline image, and then compares the two to detect changes in object type, as well as object count, position, and orientation for one or more types of objects. An alert to the user is issued if the detected changes exceed a threshold. The threshold can be established either automatically or by the user, and can be based on one, some or all monitored characteristics of the objects.

In an embodiment, the invention invites the user to identify credentials, where the credentials are of varying types and each type correlates with a level of system and/or data access. Assuming the user's credentials permit it, the user establishes an area of interest, either through geofencing or other convenient means of establishing a geographic perimeter around an area of interest. Alternatively, full satellite or other imagery is provided to permit an appropriate level of access to the data accumulated by the system. In an embodiment where the objects are multiple types of vehicles, a multiclass vehicle detection platform (MVD platform) locates vehicles in a satellite image by generating bounding boxes around each candidate vehicle in the image and classifies each candidate vehicle into one of several classes, for example car, truck, minivan, etc.).

For the sake of clarity and simplicity, the present invention is described primarily with reference to land-based vehicles. For example, one use case of the present invention is to monitor vehicles according to class, count, orientation, movement, and so on as might be found in the parking lot of a large retail store. Comparison of multiple images allows analytics to be performed concerning the volume of business the store is doing over time. How many vehicles and how long those vehicles are parked can be helpful in analyzing consumer interest in the goods sold at the store. The classes of vehicles, such as large commercial vehicles, sedans, minivans, SUV's and the like, can assist in analyzing the demographics of the customers.

The present invention can also be useful in applications associated with preservation of the environment. For example, deforestation of the rain forest is frequently accomplished by either fires or by bulldozing or illicit harvest of the forest. In either case vehicles of various classes are associated with the clearing of the land. Analysis of geospatial imagery in accordance with the invention permits identification of the classes, count, location and orientation of vehicles used in either scenario, and can be achieved in near-real-time. While the foregoing use cases involve land-based vehicles, one skilled in the art will recognize that the disclosure also applies to non-land based vehicles, for example, airplanes, helicopters, ships, boats, submarines, etc. In one embodiment, the MVD platform detects vehicles by locating and delineating any vehicle in the image and determines the class of each detected vehicle.

It is therefore one object of the present invention to provide an object detection system capable of detecting, identifying and classifying multiple classes of objects.

It is a further object of the present invention to provide an object detection system capable of detecting multiple classes of objects in near real time.

It is a still further object of the present invention to provide an multiclass vehicle detection system configured to detect at least some of position, class, and orientation.

It is a yet further object of the present invention to provide an object detection system capable of generating an alert upon detecting change in the parameters associated with one or more of the objects.

The foregoing and other objects will be better appreciated from the following Detailed Description of the Invention taken together with the appended Figures.

### THE FIGURES

FIG. 1 [Prior Art] describes a convolutional neural network typical of the prior art.

FIG. 2 shows in overall flow diagram form an embodiment of the overall system as a whole comprising the various inventions disclosed herein.

FIG. 3A illustrates in circuit block diagram form an embodiment of a system suited to host a neural network and perform the various processes of the inventions described herein.

FIG. 3B illustrates in block diagram form a convolutional neural network in accordance with the present invention.

FIG. 4A illustrates the selection of an area of interest.

FIG. 4B illustrates in plan view a parking lot having therein a plurality of vehicles of multiple classes such as might be monitored in accordance with a first use case of an embodiment of the present invention.

FIG. 4C illustrates a geospatial view of an area of rain forest subject to deforestation such as might be monitored in accordance with a second use case of an embodiment of the present invention.

FIG. 5 illustrates the selection of classes of objects for detection in the selected area of interest.

FIG. 6A illustrates in flow diagram form a method for tracking movement of an object through a plurality of images in accordance with an embodiment of the invention.

FIG. 6B illustrates in flow diagram form an object identification method in accordance with an embodiment of the invention.

FIG. 7 illustrates in flow diagram form a method for object recognition and classification using embedding and low shot learning in accordance with an embodiment of the invention.

FIG. 8 illustrates in flow diagram form a process for detecting, identifying and classifying objects so as to create an initial or baseline image in accordance with an embodiment of the invention.

FIG. 9 illustrates in flow diagram form an embodiment of a process for detector training such as might be used with the process described in connection with FIG. 7.

FIG. 10 illustrates in process form runtime detection including the use of finer feature detection maps in accordance with an embodiment of the invention.

FIG. 11A illustrates in process flow form an object classifier in accordance with an embodiment of the invention.

FIG. 11B illustrates a classifier training process in accordance with an embodiment of the invention.

FIG. 12 illustrates a process for continuous improvement of a detection and classification in accordance with an embodiment of the invention.

FIGS. 13A-13B illustrate in simplified form and in more detail, respectively, processes for cloud cover or atmospheric interference detection in accordance with an embodiment of the invention.

FIGS. 14A-14B illustrate in flow diagram form alternative processes in accordance with an embodiment of the invention for generating alerts in the event the identification, detection and classification steps yield a change in status of the monitored objects.

FIG. 15 illustrates in simplified flow diagram form a process in accordance with an embodiment of the invention for evaluating object count change between a baseline image and a new image.

FIG. 16 illustrates in flow diagram form a process in accordance with an embodiment of the invention for comparing object position and size change between a baseline image and a new image.

FIG. 17 illustrates in flow diagram form a process in accordance with an embodiment of the invention for detecting changes in object type or class between a baseline image and a new image.

FIG. 18 illustrates preprocessing steps used in preparation for evaluating object orientation changes between a baseline image and a new image.

FIG. 19 illustrates steps used in detecting object orientation changes between a baseline image and a new image.

FIG. 20 illustrates steps for training a Siamese network to assist in the process of FIG. 19 for detecting orientation changes.

FIG. 21 illustrates an embodiment of an alerting report in accordance with an embodiment of the invention generated for review and decision-making by a user.

FIG. 22 illustrates an embodiment of an alerting report showing multiple projects in accordance with an embodiment of the invention, prioritized according to urgency of alert.

### DETAILED DESCRIPTION OF THE INVENTION

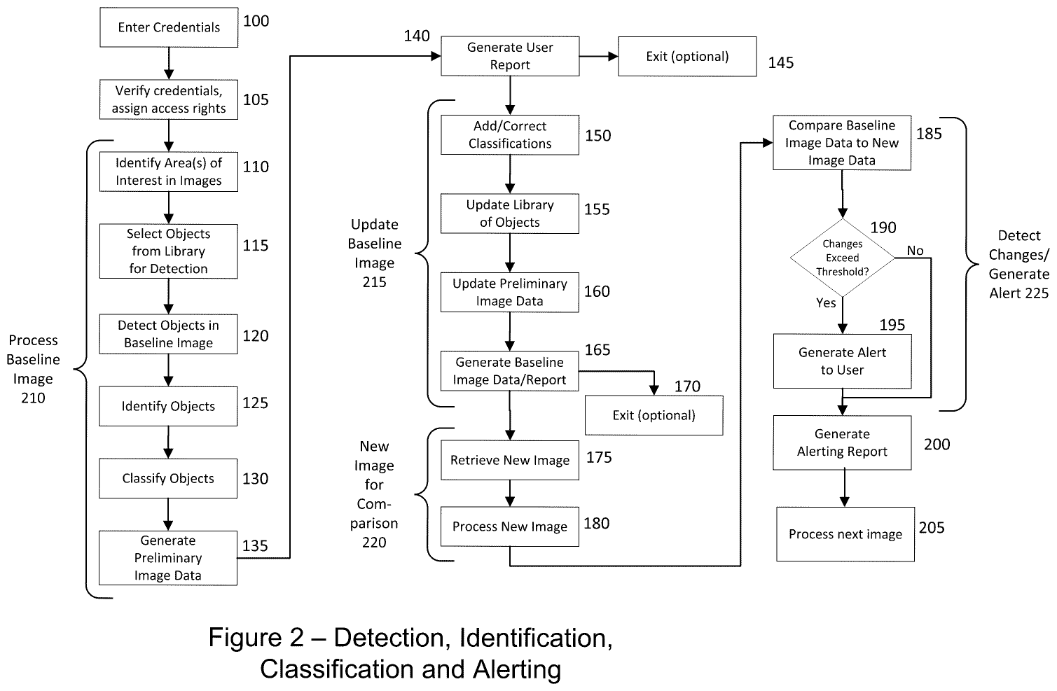

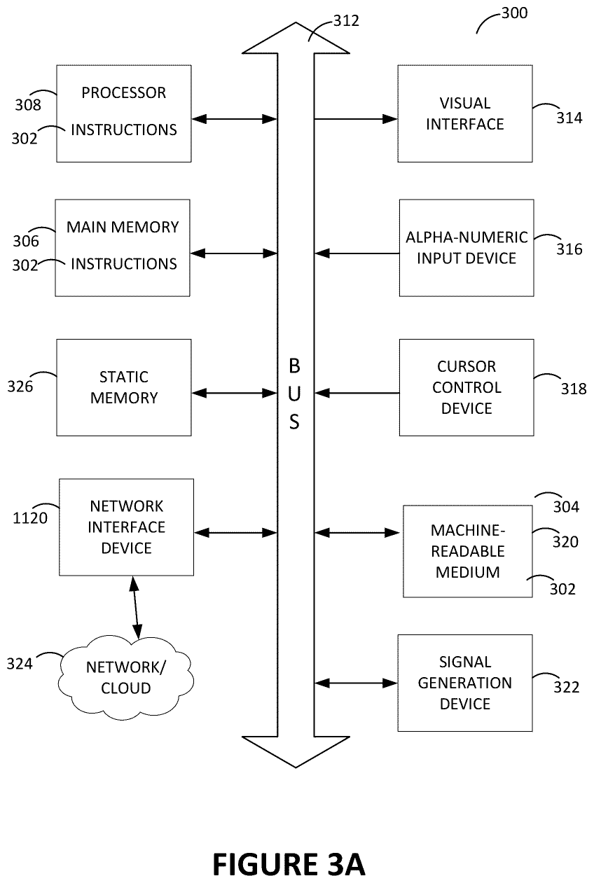

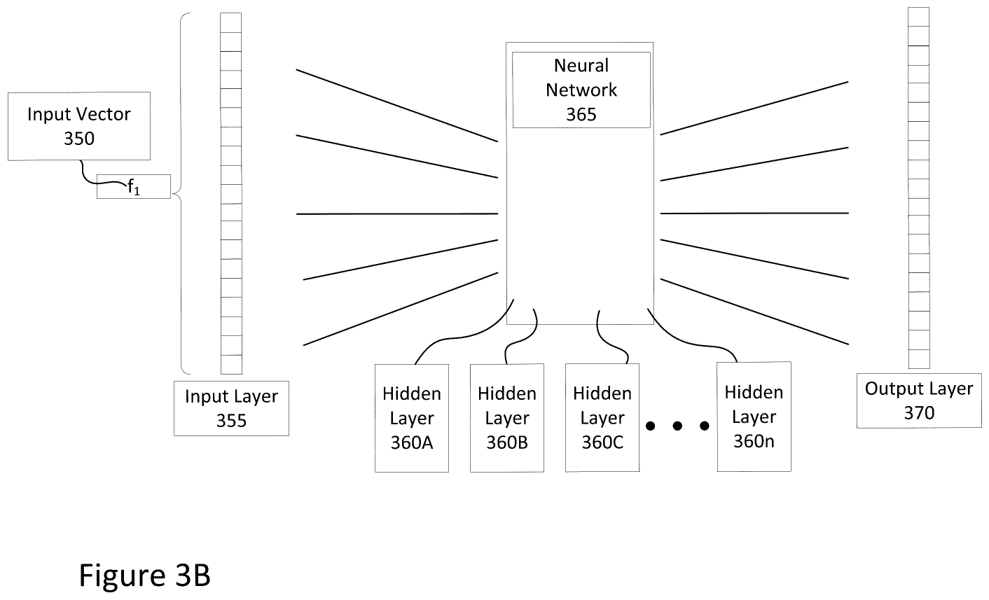

Referring first to FIG. 2, an embodiment of a system and its processes comprising the various inventions described herein can be appreciated in the whole. Discussed hereinafter in connection with FIG. 3 is illustrated a computer system suited to the performance of the processes and methods described herein. The overall process starts at 100 by a user entering his credentials. User credentials can vary in the aspects of the system the associated user is permitted to access, from being able only to view pre-existing reports to being able to direct the system to perform any and all of the processes and steps described hereinafter. The system responds at 105 by granting the appropriate access and opening the associated user interface.

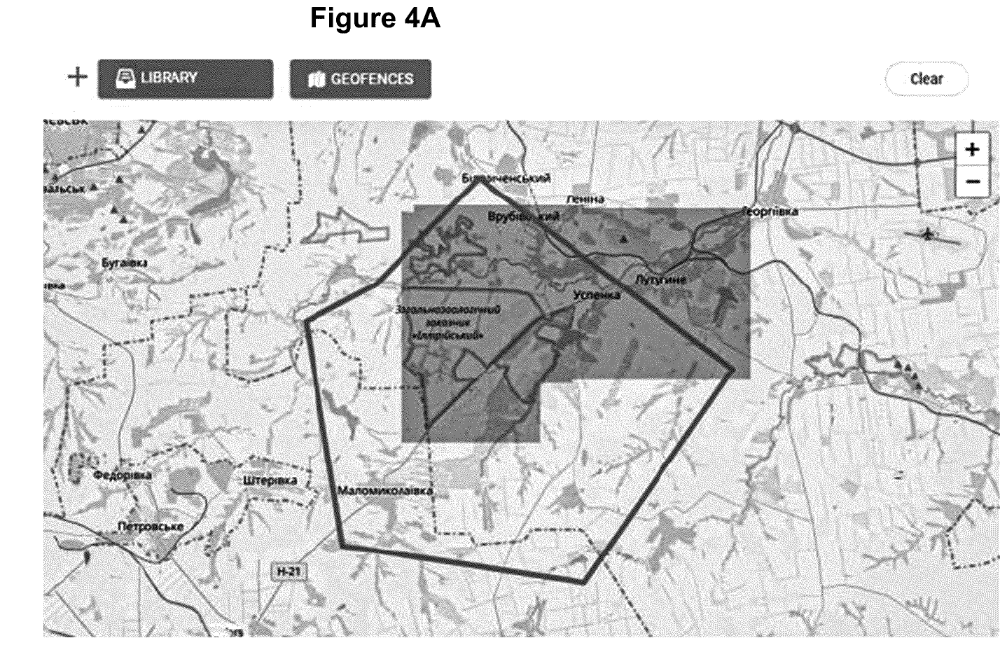

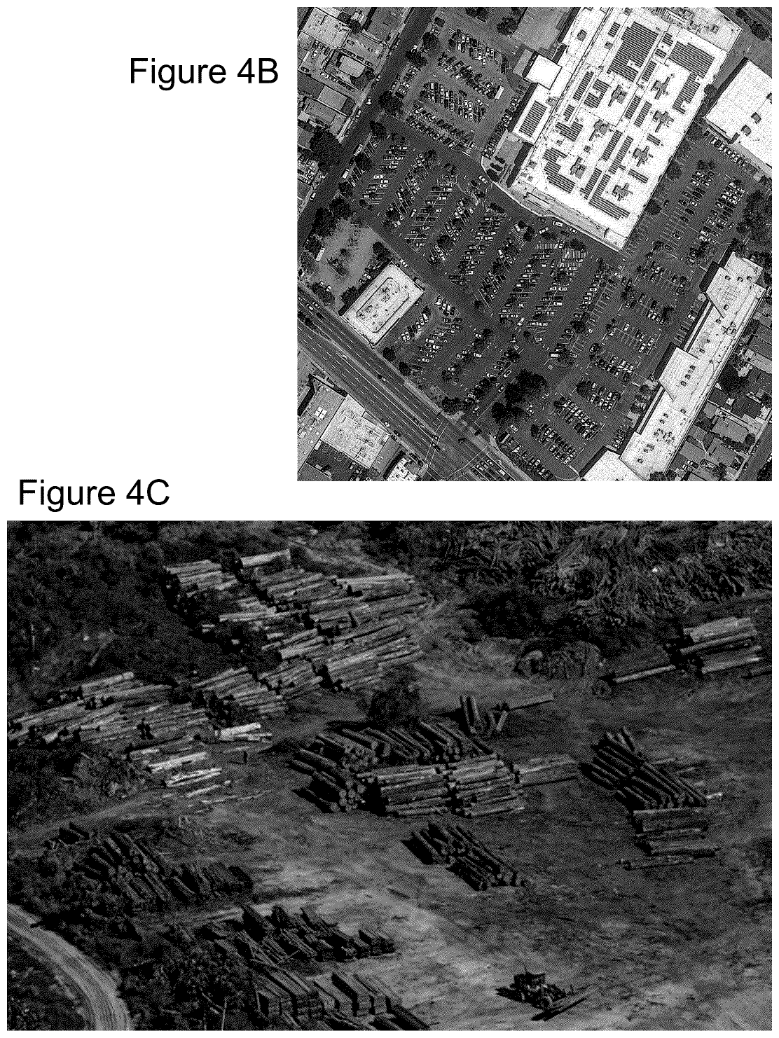

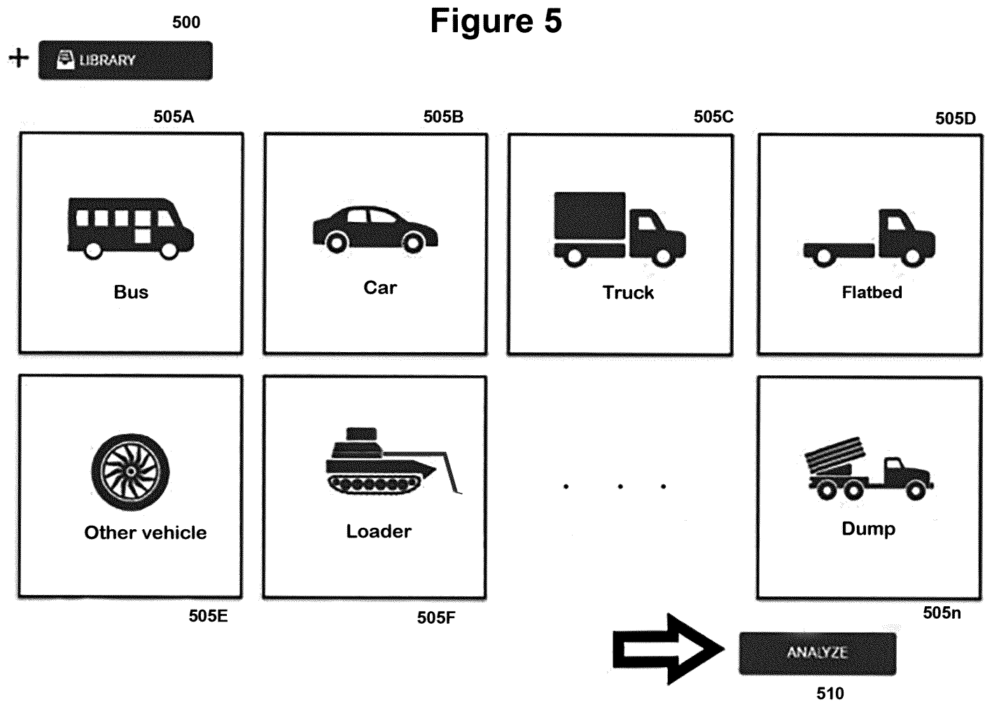

At 110, the user is permitted to select from any of a plurality of images, typically geospatial images such as satellite imagery, an area of interest as discussed further hereinafter in connection with FIG. 4A. FIGS. 4B and 4C comprise geospatial images such as might be selected in step 110. Further, as discussed in greater detail in connection with FIG. 5, an embodiment of the invention includes a library of pre-existing object definitions, or models. At step 115 the user selects from that library one or more object definitions to be detected in the areas of interest selected at step 110. The library can comprise a look-up table or other suitable format for data storage and retrieval.

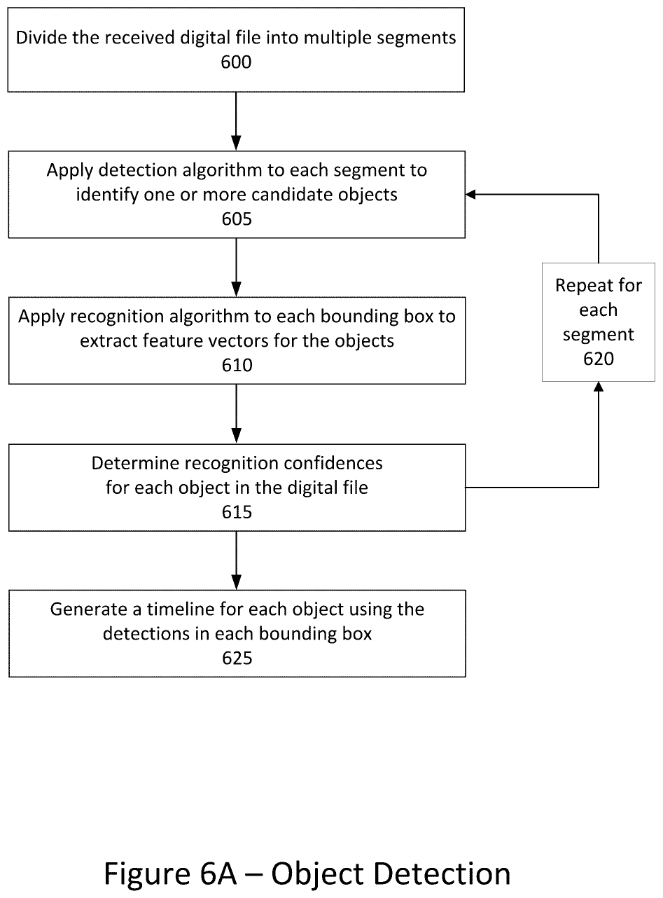

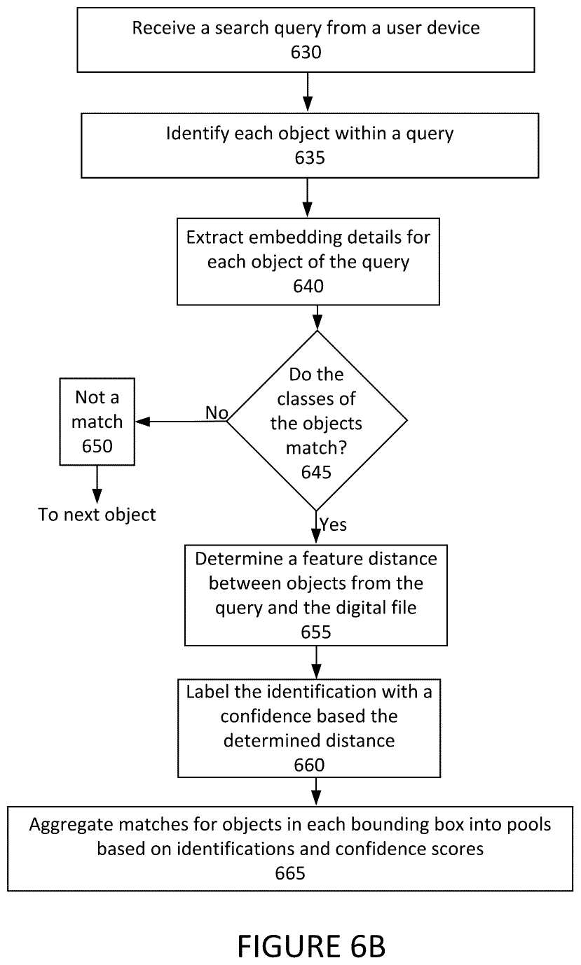

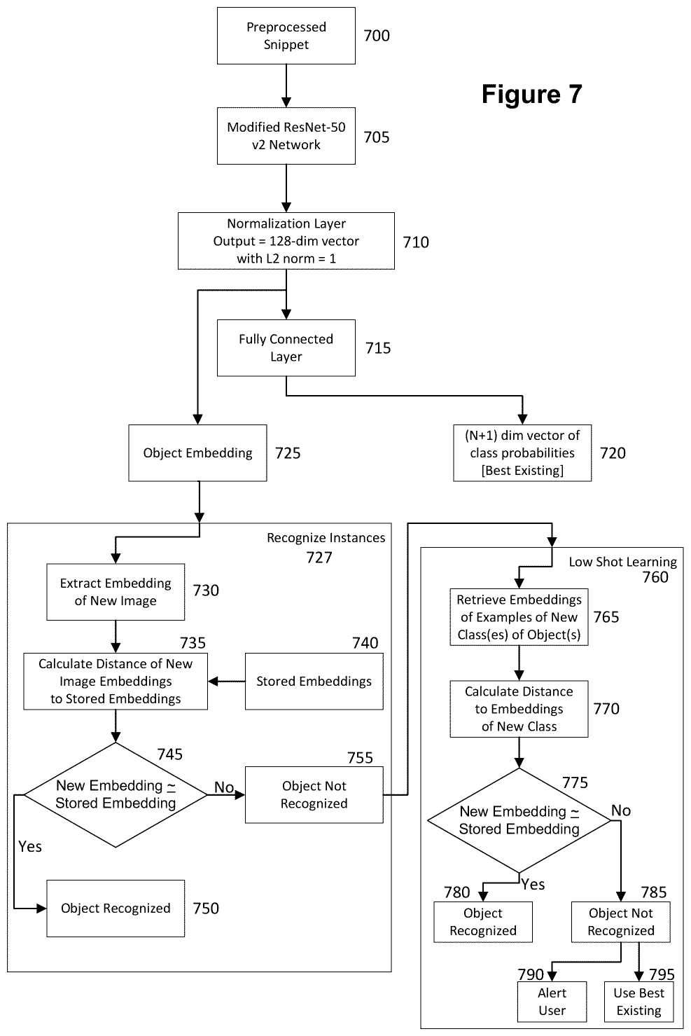

At step 120, the system performs the process of detecting in the area of interest selected at step 110 all of the objects selected at step 115. Alternatively, the system can detect all objects in the image, not just those objects selected at step 115, in which case the filtering for the selected objects can be performed at a later step, for example at the time the display is generated. The detected objects are then identified at step 125 and classified at step 130, resulting at step 135 in the generation of a data set comprising preliminary image data. That data set can take multiple forms and, in an embodiment, can characterize the classes, counts, and other characteristics of the image selected for processing at step 110. Various alternative embodiments for such identification and classification are described in connection with FIGS. 6A-6C and FIG. 7. A user report can then be generated at step 140. In some embodiments the process optionally completes at step 145.

Alternatively, the process continues at step 150 with the correction of misclassified objects or the identification of objects as being new, such that an additional classification is needed. An update to the library of objects can be performed as appropriate at step 155. In turn, the preliminary image data can be updated in response to the updated classifications, shown at 160. Updated baseline image data is then generated at step 165. Optionally, the process may exit there, as shown at 170. Alternatively, in some embodiments the process continues at step 175 with the retrieval of a new image. At step 180 the new image is processed as previously described above, with the result that a new image data set is generated in a manner essentially identical to the results indicated at steps 135 or 165. At step 185 the new image data is compared to the baseline image data. In an embodiment, if the comparison indicates that there are changes between the objects detected and classified in the new image and those detected and classified in the baseline image that exceed a predetermined threshold, an alert is generated at step 195. If an alert is generated, a report is also generated for review by either a user or an automated decision process. The alerts may be of different levels, depending upon the significance of the changes detected between the new image and the baseline image. Following generation of the report at step 200, the process essentially loops by advancing to the processing of the next image, shown at 205. From the foregoing, it can be appreciated that the present invention comprises numerous novel aspects, where an exemplary overall embodiment can be thought of at multiple different levels of detection, identification, classification, comparison, and alerting. Thus, in an embodiment, the present invention comprises processing a first, or baseline, image to create a baseline data set describing details of that image, shown at 210. The baseline data set provides information on the detection, identification, and classification of selected objects in the baseline image. That information can then be used to generate a first level of report to the user, shown at 140. In an alternative embodiment, the baseline image data set is updated to correct mis-classifications in the baseline data set, or to add new classifications, such that the baseline data set is updated with revised, and typically improved, information, shown at 215. That updated baseline data set can also be used to generate a report for analysis by a user. Then, in a still further embodiment, a new image of the same geofenced area selected at 110, typically taken at a different time, or with different image parameters (for example infrared instead of visible light), is processed to provide a new image data set, shown generally at 220. In at least some embodiments, the new image data set is configured to detect, identify and classify the same objects as the baseline data set. Then, in an embodiment, parameters of the objects of interest in the new image dataset are compared to the objects of interest in the baseline data set, shown at 225. In an embodiment, if changes are detected in selected characteristics of the monitored objects, an alert is generated to bring those changes to the attention of a user. In some embodiments, the alert is only generated if the changes exceed a threshold, which can be selected automatically or set by the user. If an alert is generated, an alerting report is provided to the user as discussed in greater detail below.

Turning next to FIG. 3A, shown therein in block diagram form is an embodiment of a machine suitable for executing the processes and methods of the present invention. In particular, the machine of FIG. 3A is a computer system that can read instructions 302 from a machine-readable medium 304 into main memory 306 and execute them in one or more processors 308. Instructions 302, which comprise program code or software, cause the system 300 to perform any one or more of the methodologies discussed herein. In alternative embodiments, the machine 300 operates as a standalone device or may be connected to other machines via a network or other suitable architecture. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 302 (sequential or otherwise) that specify actions to be taken by that machine. Further, while only a single machine is illustrated, the term “machine” shall also be taken to include any collection of machines that individually or jointly execute instructions 302 to perform any one or more of the methods or processes discussed herein.

In at least some embodiments, the computer system 300 comprises one or more processors 308. Each processor of the one or more processors 308 can comprise a central processing unit (CPU), a graphics processing unit (GPU), a digital signal processor (DSP), a controller, one or more application specific integrated circuits (ASICs), one or more radio-frequency integrated circuits (RFICs), or any combination of these. In an embodiment, the system 300 further comprises static memory 308 together with main memory 306, which are configured to communicate with each other via bus 312. The computer system 300 can further include one or more visual displays and an associated interface for displaying one or more user interfaces, all indicated at 314. The visual displays may be of any suitable type, such as monitors, head-up displays, windows, projectors, touch enabled devices, and so on. At least some embodiments further comprise an alphanumeric input device 316 such as a keyboard, touchpad or touchscreen or similar, together with a pointing or other cursor control device 318 such as a mouse, a trackball, a joystick, a motion sensor, a touchpad, a tablet, and so on. ent), a storage unit 320 wherein the machine-readable instructions 302 are stored, a signal generation device 322 such as a speaker, and a network interface device 326. In an embodiment, all of the foregoing are configured to communicate via the bus 312, which can further comprise a plurality of buses, including specialized buses.

Although shown in FIG. 3A as residing in storage unit 320 on machine-readable medium 304, instructions 302 (e.g., software) for causing the execution of any of the one or more of the methodologies, processes or functions described herein can also reside, completely or at least partially, within the main memory 306 or within the processor 308 (e.g., within a processor's cache memory) during execution thereof by the computer system 300. In at least some embodiments, main memory 306 and processor 308 also can comprise machine-readable media. The instructions 302 (e.g., software) can also be transmitted or received over a network 324 via a network interface device 326.

While machine-readable medium 304 is shown in an example embodiment to be a single medium, the term “machine-readable medium” should be taken to include a single medium or multiple media (e.g., a centralized or distributed database, or associated caches and servers) able to store instructions (e.g., instructions 302). The term “machine-readable medium” includes any medium that is capable of storing instructions (e.g., instructions 302) for execution by the machine and that cause the machine to perform any one or more of the methodologies disclosed herein. The term “machine-readable medium” includes, but is not limited to, data repositories in the form of solid-state memories, optical media, and magnetic media.

FIG. 3B shows in block diagram form the architecture of an embodiment of a convolutional neural network suited to performing the methods and processes of the invention. Some aspects of its capabilities are described in U.S. patent application Ser. No. 16/120,128, filed Aug. 31, 2018, and incorporated herein by reference in its entirety. Those skilled in the art will recognize that architecture shown in FIG. 3B comprises a software functionality executed by the system of FIG. 3A, discussed above. In general, a convolutional neural network leverages the fact that an image is composed of smaller details, or features, and creates a mechanism for analyzing each feature in isolation, which informs a decision about the image as a whole. The neural network 350 receives as its input an input vector that describes various characteristics of a digital image. In the context of the present invention, a “vector” is described as “n-dimensional” where “n” refers to the number of characteristics needed to define an image, or, in some embodiments, a portion of an image. Even for two dimensional images such as a picture of an object against a background, the number of characteristics needed to define that object against that background can be quite large. Thus, digital image processing in accordance with the present invention frequently involves vectors that are 128-dimensional or more. Referring still to FIG. 3B, the input vector 350 is provided to an input layer 360 that comprises one input for each characteristic, or dimension, of the input vector 350. Thus, for an input vector that is 128-dimensional, the input layer 355 comprises 128 inputs, or nodes.

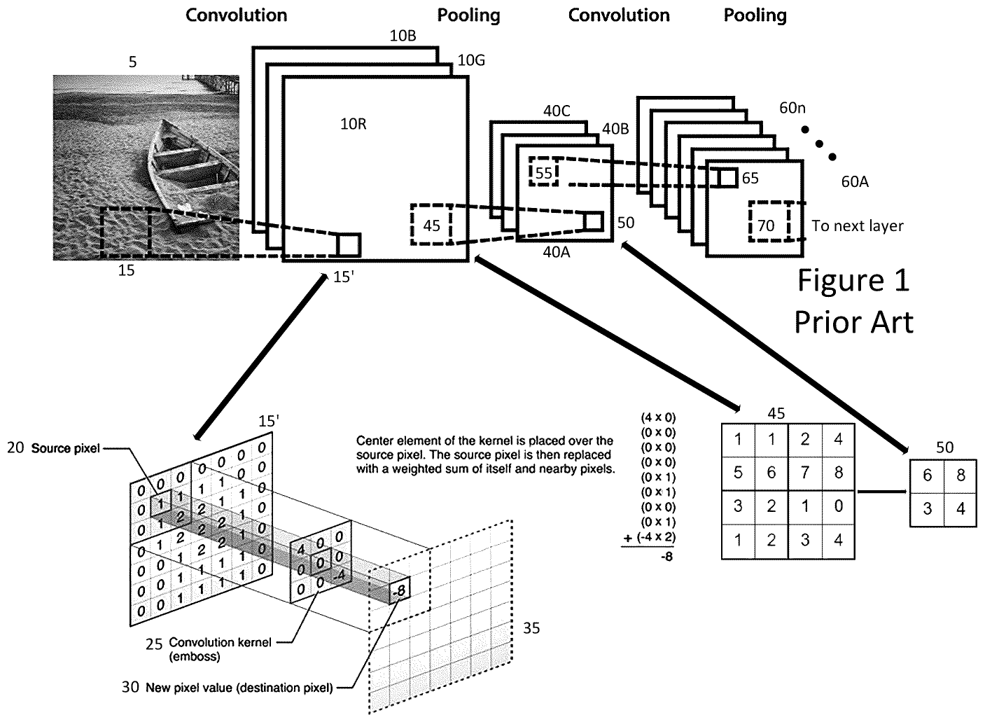

As with the neural network illustrated in FIG. 1, the input nodes of input layer 355 are passive, and serve only to supply the image data of the input vector 350 to a plurality of hidden layers 360A-360n that together comprise neural network 365. The hidden layers are typically convolutional layers. Simplifying for clarity, in a convolutional layer, a mathematical filter scans a few pixels of an image at a time and creates a feature map that at least assists in predicting the class to which the feature belongs. The number of hidden layers, and the number of nodes, or neurons, in each hidden layer will depend upon the particular embodiment and the complexity of the image data being analyzed. A node characteristic can represent data such as a pixel or any other data to be processed using the neural network 365. The characteristics of each node can be any values or parameters that represent an aspect of the image data. Where neural network 365 comprises a plurality of hidden layers, the neural network is sometimes referred to as a deep neural network.

Again simplifying for clarity, the nodes of the multiple hidden layers can be thought of in some ways as a series of filters, with each filter supplying its output as an input to the next layer. Input layer 355 provides image data to the first hidden layer 360A. Hidden layer 360A then performs on the image data the mathematical operations, or filtering, associated with that hidden layer, resulting in modified image data. Hidden Layer 360A then supplies that modified image data, to hidden layer 360B, which in turns performs its mathematical operation on the image data, resulting in a new feature map. The process continues, hidden layer after hidden layer, until the final hidden layer, 360n, provides its feature map to output layer 370. The nodes of both the hidden layers and the output layer are active nodes, such that they can modify the data they receive as an input.

In accordance with an embodiment of the invention, each active node has one or more inputs and one or more outputs. Each of the one or more inputs to a node comprises a connection to an adjacent node in a previous layer and an output of a node comprises a connection to each of the one or more nodes in a next layer. That is, each of the one or more outputs of the node is an input to a node in the next layer such that each of the nodes is connected to every node in the next layer via its output and is connected to every node in the previous layer via its input. In an embodiment, the output of a node is defined by an activation function that applies a set of weights to the inputs of the nodes of the neural network 365, typically although not necessarily through convolution. Example activation functions include an identity function, a binary step function, a logistic function, a TanH function, an ArcTan function, a rectilinear function, or any combination thereof. Generally, an activation function is any non-linear function capable of providing a smooth transition in the output of a neuron as the one or more input values of a neuron change. In various embodiments, the output of a node is associated with a set of instructions corresponding to the computation performed by the node, for example through convolution. As discussed elsewhere herein, the set of instructions corresponding to the plurality of nodes of the neural network may be executed by one or more computer processors. The hidden layers 360A-360n of the neural network 365 generate a numerical vector representation of an input vector where various features of the image data have been extracted. As noted above, that intermediate feature vector is finally modified by the nodes of the output layer to provide the output feature map. Where the encoding and feature extraction places similar entities closer to one another in vector space, the process is sometimes referred to as embedding.

In at least some embodiments, each active node can apply the same or different weighting than other nodes in the same layer or in different layers. The specific weight for each node is typically developed during training, as discussed elsewhere herein. The weighting can be a representation of the strength of the connection between a given node and its associated nodes in the adjacent layers. In some embodiments, a node of one level may only connect to one or more nodes in an adjacent hierarchy grouping level. In some embodiments, network characteristics include the weights of the connection between nodes of the neural network 365. The network characteristics may be any values or parameters associated with connections of nodes of the neural network.

With the foregoing explanations in mind regarding the hardware and software architectures that execute the operations of various embodiments of the invention, the operation of the system as generally seen in FIG. 2 can now be explained in greater detail. As shown at steps 100 to 110 in FIG. 2, a user selects a specific image that he wishes to monitor for specific objects in an area of interest. The process then proceeds with the development of a baseline data set, shown generally at 210 in FIG. 2. With reference to FIG. 4A, a selected geospatial image 400 typically comprises an area considerably greater than the area of interest 405 that the user wishes to monitor for detection of selected objects. The user establishes the boundaries of the area of interest by geofencing by any convenient means such as entry of coordinates, selection of vertexes on a map, and so on. In some instances, stored geofences can be retrieved as shown at 410. A single image may include a plurality of areas of interest, In at least some embodiments, each area of interest is processed separately. FIGS. 4B and 4C comprise different use cases of the invention. FIG. 4B is a photograph of a parking lot for a retail store, and includes a variety of vehicles. In one use case of the invention, the parking lot is monitored for the volume and types of vehicles, and baseline image data is compared to image data at other times. Based on the changes in the volume and types of vehicles, business activity can be analyzed. Greater depth of analysis is possible when store revenues are incorporated, including revenue per visit, per vehicle, and so on. FIG. 4C depicts a different use case. FIG. 4C shows piles of lumber from a deforested area of the Amazon rain forest. By monitoring the changes in the piles, the activities of the vehicles, and the activities of any people in the image, a variety of inferences can be drawn about the nature and propriety of the activity.

Referring next to FIG. 5, and also to step 115 in FIG. 2, once the image to be monitored has been selected and an area of interest identified, the user selects the type of objects to be detected and classified from within that area of interest. In an embodiment, the user is presented with a library as shown at 500 in FIG. 5. By selecting that menu, an array of known objects 505A-505n is provided on the system display. The objects can be of any sort for which the system and its convolutional neural network are trained. For simplicity and clarity, the objects 505A-505n are vehicles, but could be logs, bicycles, people, and so on, or any combination of these or other objects. The user selects one or more of the known objects as targets for monitoring, and clicks “analyze” shown at 510 to begin the detection, identification and classification process described in detail hereinafter. Again for the sake of simplicity, the remaining discussion will use vehicles as exemplary objects, with the understanding that the present invention can detect, identify and classify s multitude of other types of objects or combinations of types of objects.

Once the user has selected the satellite or other image and designed an area of interest in that image, the process of developing a baseline data set begins, as shown generally at 210 in FIG. 2 and more specifically in FIG. 6A et seq. Referring first to FIG. 6A, the system's responses to the “analyze” command initiated through FIG. 5 can be better appreciated. FIG. 6A is similar to FIG. 4 of U.S. patent application Ser. No. 16/120,128 filed Aug. 31, 2018, incorporated herein by reference in its entirety. FIG. 6A shows in flow diagram form an embodiment of a process for detecting objects in a digital image file in accordance with the invention. In some embodiments, the digital image file is divided into multiple segments as shown at 600, with each segment being analyzed as its own digital image file. In an embodiment, as shown at 605, areas of the digital image or segment that represent candidates as objects of interest are identified and isolated from the background by generating a bounding box around those areas of the image, i.e., the relevant portions of the digital image file. At 610 a recognition algorithm is applied to each candidate to compare the candidate to a target object as identified by the user as discussed in connection with FIG. 5. The recognition algorithm, using convolutional filtering, extracts feature vectors from the data representing the candidate object, and compares those feature vectors to the feature vector representative of the known target object. The system then completes initial processing of the candidate by determining, at 615, a recognition assessment indicating the level of confidence that the candidate matches the target object and then recording appropriate location data for the processed candidate. As indicated at 620, the process then loops back to step 605 to process each remaining segment in accordance with steps 605-615. Once the last segment or digital image is processed, the data is aggregated data to represent each segment, shown at 625. In the event the images comprise a temporal sequence, a time line for each object can also be generated if desired.

In at least some embodiments, the recognition algorithm is implemented in a convolutional neural network as described in connection with FIG. 3B, where the feature vectors are extracted through the use of the hidden layers discussed there. The neural network will preferably have been trained by means of a training dataset of image where samples of the target objects are identified in an appropriate manner, and wherein the target objects are presented within bounding boxes. The identification, or label, for each sample can be assigned based on a comparison of a given feature to a threshold value for that feature. The training process can comprise multiple iterations with different samples. In an embodiment, at the end of each iteration, the trained neural network runs a forward pass on the entire dataset to generate feature vectors representing sample data at a particular layer. These data samples are then labeled, and are added to the labeled sample set, which is provided as input data for the next training iteration.

In an embodiment, to improve the accuracy of matches made between candidate objects and known target objects, the resolution of the boundary box can be increased to a higher recognition resolution, for example the original resolution of the source digital image. Rather than extracting feature vectors from the proportionally smaller bounding box within the segment provided to the detection algorithm (e.g. 512×512) during the detection stage, the proportionally larger bounding box in the original image can be provided to the recognition module. In some implementations, adjusting the resolution of the bounding box involves mapping each corner of the bounding box from their relative locations within a segment to their proportionally equivalent locations in the original image, which can, depending upon the embodiment and the data source, be a still image or a frame of video. At these higher recognition resolutions, the extraction of the feature vector from the detected object can be more accurate.

FIG. 6B illustrates in flow diagram form an object identification method in accordance with an embodiment of the invention, and is also similar to that discussed in U.S. patent application Ser. No. 16/120,128 filed Aug. 31, 2018, incorporated herein by reference in its entirety. To implement the object recognition process, FIG. 6B shows in flowchart form an embodiment of a process for identifying matches between targets in accordance with the invention. In particular, when the user clicks “analyze” in FIG. 5, a query is initiated in the system of FIG. 2 and hardware and neural network architecture of FIGS. 3A-3B. As described generally above and in greater detail in connection with FIG. 7 among others, a search query is received from the user interface at step 630. At step 635 each target object within the query is identified. For each target object, feature vectors are extracted at 640 from the data describing the physical properties of each known object. Using convolution or other suitable technique, the process iteratively filters through the digital image file to compare the feature vector of each known target object to the feature vector of each unidentified object in the image being processed. Before comparing physical properties between the two feature vectors, the classes of the two objects are compared at step 645. If the objects do not match, the recognition module recognizes that the two objects are not a match, step 650 and proceeds to analyze the next unidentified object within the file. If the objects classes do match, the remaining features of the feature vectors are compared and, for each match, a distance between the two feature vectors is determined at 655. Then, at step 660, for each match, a confidence score is assigned based on the determined distance between the vectors. Finally, at 665, the data for the detected matches between the unidentified objects and the known target objects is aggregated into pools derived from the query terms and the digital images or segments within each pools are organized by confidence scores.

In an alternative embodiment to that shown in FIG. 6B, step 655 is performed ahead of step 645. In such an alternative embodiment, the feature distance determined at step 655 can then be used to determine if there is a match. If there is no match, low shot learning as discussed hereinafter (FIG. 7) can be performed on the reference embeddings for new classes.

Referring next to FIG. 7, an alternative embodiment of the process of object recognition in accordance with the present invention can be appreciated. The process begins at step 700 with the presentation of a pre-processed snippet, which is a portion of the image file that has been scaled, channelized and normalized relative to the known target data. In an embodiment, and shown at 705, the snippet serves as the input to a modified ResNet50 model with, for example, forty-eight convolution layers together with a single MaxPool and a single AveragePool layer. In such an embodiment, the normalization layer outputs a 128-dimension vector with an L2 normalization of 1. That output is supplied to a fully connected layer 715 which in turn generates at step 720 an (N+1) dimensional vector of class probabilities based on the existing models stored in the system.

Object embedding is performed at step 725 followed by an instance recognition process denoted generally at 727. The process 727 comprises extracting the embedding of the new image at step 730, followed at 735 by calculating the distance between the new image embeddings and the embeddings of the known, stored object, which are retrieved from memory as shown at 740. If the new embedding is sufficiently similar to the stored embedding, the new object is recognized as a match to the stored target object, shown at 750. However, if the new object is too dissimilar to the stored object, the object is not recognized, step 755, and the process advances to a low-shot learning process indicated generally at 760. In that process, embeddings of examples of new class(es) of objects are retrieved, 765, and the distance of the object's embeddings to the new classis calculate, 770. If the new embedding is sufficiently similar to the embedding of the new class of stored objects, tested at 775, the object is recognized as identified at step 780. However, if the test shows insufficient similarity, the object is not recognized, 785. In this event the user is alerted, 790, and at 795 the object is indicated as a match to the closest existing class as determined from the probabilities at 720.

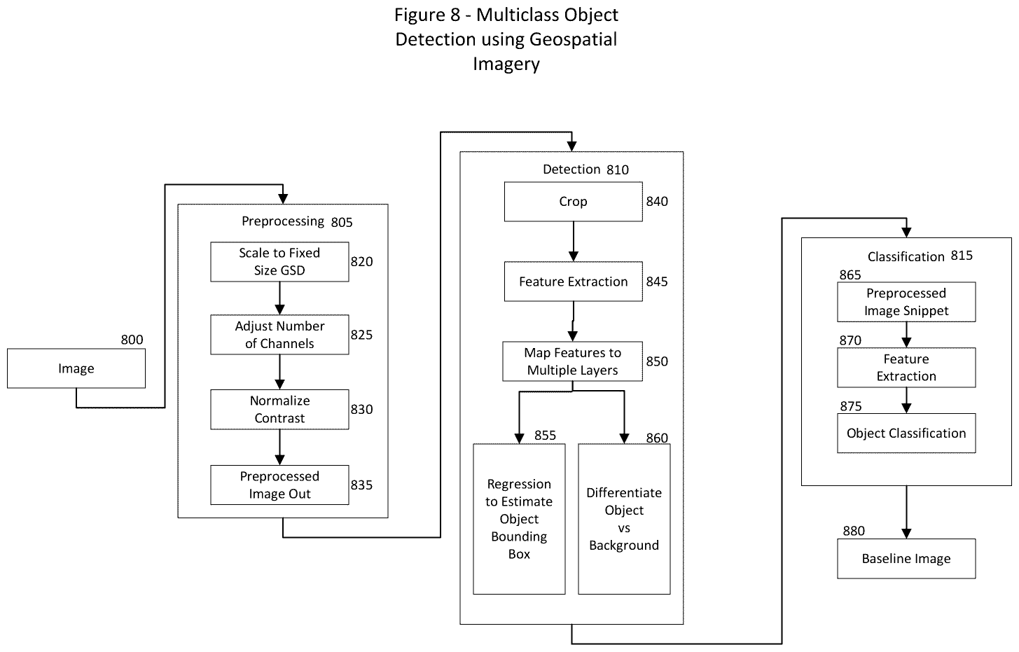

Referring next to FIG. 8, a still further alternative embodiment can be appreciated. The embodiment of FIG. 8 is particularly suited to multiclass object detection, and, for convenience, is discussed in the context of multiclass vehicle detection, sometimes abbreviated as MVD. While the following description is discussed in connection with land-based vehicles, those with ordinary skill in the art will recognize that the invention applies equally well to other types of vehicles including airplanes, helicopters, boats, submarines, and also objects other than vehicles.

In an embodiment, an MVD platform comprises an object detector and an object classifier. The object detector receives a satellite image as an input and outputs locations of vehicles in the satellite image. Based on the locations, the object detector generates a bounding box around each vehicle in the image. In such an embodiment, the processing of an image 800 can generally be divided into three major subprocesses: preprocessing, indicated at 805, detection, indicated at 810, and classification, indicated at 815.

Preprocessing can involve scaling the image horizontally and vertically to map the image to a standard, defined Ground Sampling Distance, for example 0.3 meters per pixel, shown at 820. Preprocessing can also involve adjusting the number of channels, for example modifying the image to include only the standard RGB channels of red, green and blue. If the original image is panchromatic but the system is trained for RGB images, in an embodiment the image channel is replicated three times to create three channels, shown at 825. The contrast of the channels is also typically normalized, step 830, to increase the color range of each pixel and improve the contrast measurement. Such normalization can be achieved with the below equation

$$( {\hat{R}}_{i} , {\hat{G}}_{i} , {\hat{B}}_{i} ) = ( \frac{{R}_{i} - {μ}_{R}}{{σ}_{R}} , \frac{{G}_{i} - {μ}_{G}}{{σ}_{G}} , \frac{{B}_{i} - {μ}_{B}}{{σ}_{B}} )$$

Where:
\hat{R}ᵢ, Ĝᵢ, \hat{B}ᵢ is the contrast normalized color at a pixel position i.
(μ_{R}, μ_{G}, μ_{B}) are the means of the red, green, and blue channels in the image.
σ_{R}, σ_{G}, σ_{B}) are the standard deviations of the red, green, and blue channels in the image.
   After normalizing the contrast, the processed image is output at 835 to the detection subprocess indicated at 810. The detection process is explained in greater detail hereinafter, but in an embodiment starts with cropping the image, indicated at 840. The cropped image is then input to a deep neural network which performs feature extraction, indicated at 845, the result of which maps the extracted features to multiple layers of the neural network, indicated at 850.

In some embodiments, deep neural networks, which have multiple hidden layers, are trained using a set of training images. In some implementations, training data for the vehicle detector and vehicle classifier may be initially gathered manually in a one-time operation. For example, a manual labeling technique may label all vehicles in a given satellite image. Each vehicle is manually marked with its bounding box, and its type. During training, all vehicles are labeled in each image, regardless of whether a vehicle belongs to one of the N vehicle classes that are of current interest to a user. Vehicles that are not included in any of the N classes may be labeled with type “Other vehicle”, resulting in a total of N+1 classes of vehicles. The data collected from the initial labeling process may be stored in the system of FIGS. 3A and 3B to generate a training data set for use (or application) with a machine learning model. The machine learning model may incorporate additional aspects of the configuration disclosed herein. A computing system may subsequently execute that machine learning model to identify or suggest labels in later captured satellite imagery.

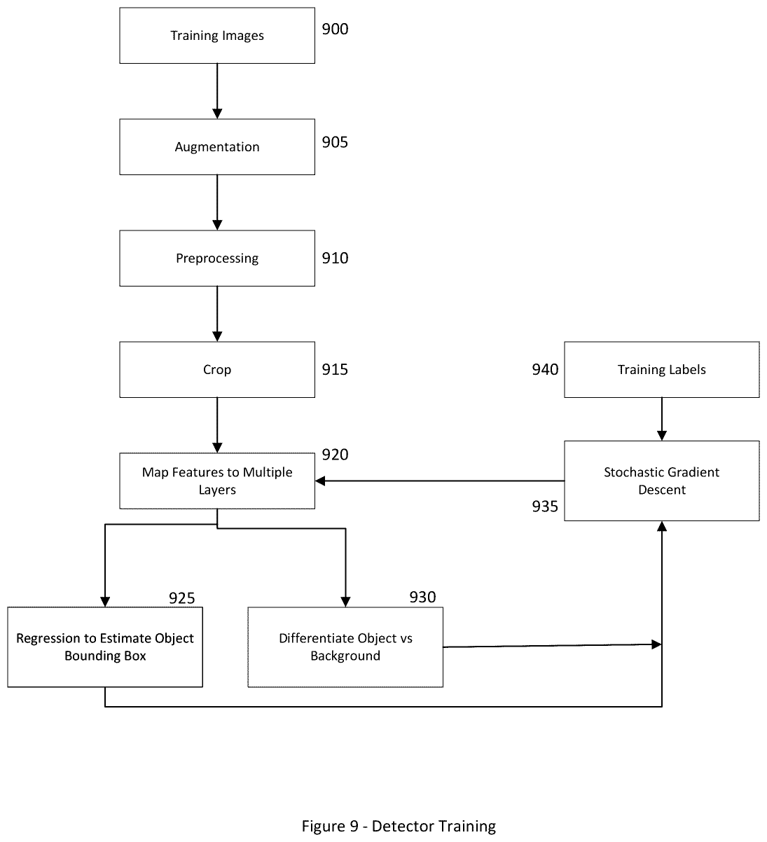

FIG. 9 illustrates in flow diagram form a detection training process in accordance with an embodiment of the invention. In one example embodiment, a set of training images is provided at step 900, and those images are, in some embodiments, augmented, step 905, to provide expand the size of the training dataset by creating modified versions of the images, or at least a portion of the images, to reduce the occurrence of false positives and false negatives during runtime detection, discussed hereinafter. Stated differently, image augmentation improves the ability of the neural network to generalize their training so that new images are properly evaluated. In some embodiments, images may be augmented by shifting, flipping, changing brightness or contrast, adjusting lighting to create or reduce shadows, among other augmentation techniques. The images in the dataset may also be preprocessed, step 910, using techniques such as those shown in FIG. 8 at 805. In an embodiment, the neural network may be configured to generate bounding boxes around specific portions of an image, such as those portions that contain all or part of a vehicle. In such an embodiment, the neural network can be trained on pre-processed imagery cropped into tiles of predetermined size, for example 512 pixels×512 pixels, as shown at step 915. Map features can be mapped to multiple layers, shown at step 920. The loss function of the trained neural network accounts for the square bounding boxes, step 925. Further, in such an embodiment, the loss function yields better results when more accurate centers of vehicles are used rather than vehicular sizes. In an embodiment, centers of detected vehicles are determined using snippet sizes of 48×48 pixels around the center of the detected vehicle. To determine the overall loss, the same expression can be used but with modification of the location error term L_{loc} to account for square snippets, and by modifying the coefficient β where β>1 to provide more weight on the size and less on location, as follows:

$$L ( x , l , g ) = {\sum }_{i ∈ Pos}^{N} [ β ( {\sum }_{m ∈ ( cx , cy )} {x}_{ij}^{k} {smooth}_{L 1} ( {l}_{i}^{m} - {\hat{g}}_{j}^{m} ) ) + {x}_{ij}^{k} {smooth}_{L 1} ( {l}_{i}^{s} - {\hat{g}}_{j}^{s} ) ] \\ Where : \\ {\hat{g}}_{j}^{cx} = ( {g}_{j}^{cx} - {d}_{i}^{cx} ) / {d}_{i}^{s} \\ {\hat{g}}_{j}^{cy} = ( {g}_{j}^{cy} - {d}_{i}^{cy} ) / {d}_{i}^{s} \\ {\hat{g}}_{j}^{s} = log ( \frac{{g}_{j}^{s}}{{d}_{i}^{w}} ) \\ {smooth}_{L 1} ( x ) = \{ \begin{matrix}0.5 {x}^{2} , & if \vert x \vert < 1 \\ \vert x \vert - 0.5 , & otherwise\end{matrix} \\ {x}_{ij}^{k} ∈ ( 0 , 1 )$$

is an indicator that associates the ith default box to the jth ground truth box for object class k, g denotes ground truth boxes, d denotes default boxes, I denotes predicted boxes, (cx, cy) denote the x and y offsets relative to the center of the default box, and finally s denotes the width (and height) of the box. In some example embodiments, the network is further trained using negative sample mining. Through the use of such an approach, the neural network is trained such that incorrectly placed bounding boxes or cells incorrectly classified as vehicles versus background result in increased loss. The result is that reducing loss yields improved learning, and better detection of objects of interest in new images.

Based on the granularity at which they were generated, a feature map will control the region of an image that the regression filter is processing to generate an associated bounding box. For example, a 128×128 feature map presents a smaller image of an area surrounding a center than a 64×64 feature map and allows an object detector to determine whether an object is present at a higher granularity.

In an embodiment, a training data set is augmented using one or more of the following procedures:
1. A cropped tile of an image is randomly translated by up to 8 pixels, for example by translating the full image first and re-cropping from the translated image, so that there are no empty regions in the resulting tile.
2. The tile is randomly rotated by angles ranging in [0, 2π), for example by rotating a 768×768 tile and creating a crop of 512×512 pixels around the tile center.
3. The tile is further perturbed for contrast and color using various deep neural network software frameworks, for example TensorFlow, MxNet, and PyTorch.
   Through these techniques, objects of interest are differentiated from image background, as shown at step 930.

Further, in at least some embodiments, the network weights are initialized randomly and the weights are optimized through stochastic gradient descent, as shown at 935. The results can then be fed back to the multiple layers, step 920. Training labels can be applied as shown at step 940. As will be well understood by those skilled in the art, the objective of such training is to help the machine learning system of the present invention to produce useful predictions on never-before-seen data. In such a context, a “label” is the objective of the predictive process, such as whether a tile includes, or does not include, an object of interest.

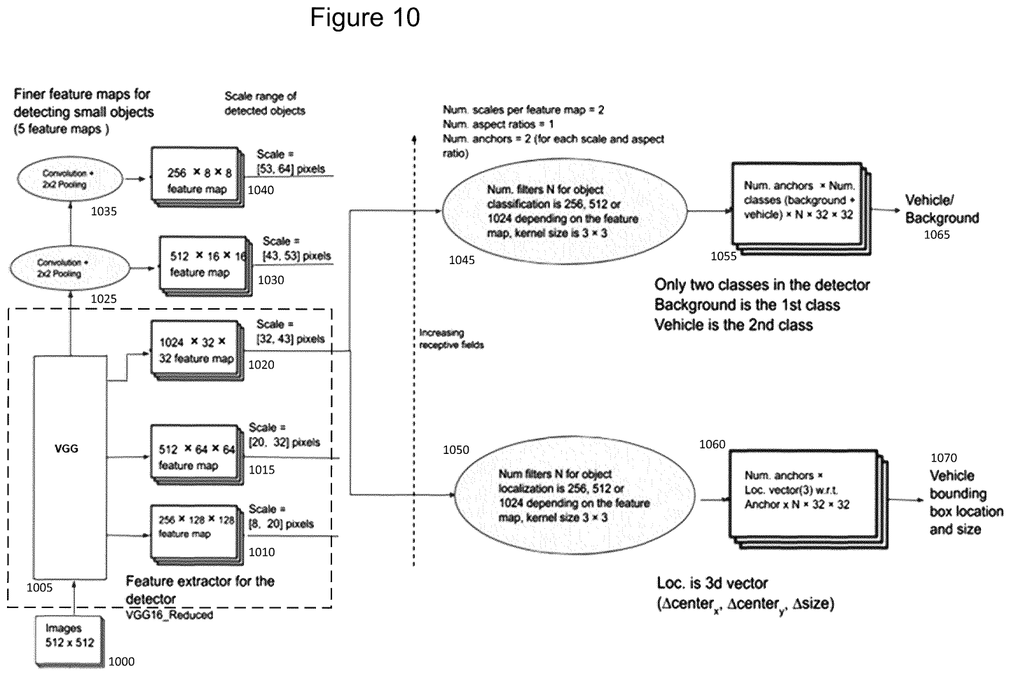

Once at least initial detection training of the neural network has been completed, an embodiment of the system of the present invention is ready to perform runtime detection. As noted several times above, vehicles will be used for purposes of simplicity and clarity, but the items being detected can vary over a wide range, including fields, boats, people, forests, and so on as discussed hereinabove. Thus, with reference to FIG. 10, an embodiment of an object detector in accordance with the present invention can be better understood.

In an embodiment, shown in FIG. 10, the object detector executes the following steps to detect vehicles:

An image, for example a satellite image with improved contrast, is cropped into overlapping tiles, for example cropped images of 512 pixels×512 pixels, shown in FIG. 10 at step 1000. As discussed herein, dimensions of a cropped image are described in numbers of pixels. In some implementations, part of a vehicle may be located in a first tile and another part of a vehicle may be located in a second tile immediately adjacent to the first file. To detect such vehicles, overlapping cropped images are generated such that vehicles that span the borders of some tiles are completely detected in at least one cropped image.

Once the image has been cropped into tiles, each tile (or cropped image) is input to a backend feature extractor, shown at 1005. The objective of the feature extractor is to identify characteristics that will assist in the proper detection of an object such as a vehicle in the tile being processed. In an embodiment, feature extractor 1005 can be a VGG-16 reduced structure, and may be preferred for improved detection accuracy on low resolution objects. In other embodiments, any backend neural network such as inception, resnet, densenet, and so on can be used as a feature extractor module. For an embodiment using a VGG-16 reduced network for feature extractor 1005, the extractor 1005 takes, for example, 512×512 normalized RGB channel images as inputs and applies multiple (e.g., seven) groups of convolutional kernels (group1-group7, not shown for simplicity) that are composed of different numbers (64, 128, 256, 512, 512, 1024, 1024) of filters, followed by ReLU activations. The feature maps used for making predictions for the objects at different scales are extracted as filter responses of the convolution operations applied to the inputs of each of the intermediate layers of the network. Thus, of the seven groups that comprise at least some embodiments of a VGG-16 Reduced feature extractor, three feature maps are pulled out as shown at 1010, 1015, and 1020. These bottom three feature maps, used for detecting smaller objects, are extracted as filter responses from the filter group3, filter group4 and the filter group7 respectively. The top two feature maps, used for detecting larger objects, are computed by repeatedly applying convolution and pooling operations to the feature map obtained from group7 of the VGG-16 reduced network.

In the present invention, pooling can be useful to incorporate some translation invariance, so that the max pooled values remain the same even if there is a slight shift in the image. Pooling can also be used to force the system to learn more abstract representations of the patch by reducing the number of dimensions of the data. More particularly, pooling in the context of the present invention causes the network to learn a higher level, more abstract concept of a chair by forcing the network to use only a small set of numbers in its final layer. This causes the network to try to learn an invariant representation of a given object, that is, one that distills the object down to its elemental features. In turn, this helps the network to generalize the concept of a given object to versions of the object not yet seen, enabling accurate detection and classification of an object even when seen from a different angle, in different lighting, and so on.

The output of the feature extractor is processed by a feature map generator at different sizes of receptive fields. As discussed above, the feature map processor processes cropped images at varying granularities, or layers, including 128×128, 64×64, 32×32, 16×16, and 8×8, shown at 1010, 1015, 1020, 1030 and 1040 and in order of increasing granularity respectively. In an embodiment, feature extraction can be enhanced by convolution plus 2×2 pooling, such as shown at 1025 and 1035, for some feature maps such as 1030 and 1040. As shown for each feature map processor, each image may also be assigned a depth measurement to characterize a three-dimensional representation of the area in the image. Continuing from the above example, the depth granularity of each layer is 256, 512, 1024, 512, and 256, respectively. It will be appreciated by those skilled in the art that, like the other process elements shown, the feature map processors are software processes executed in the hardware of FIG. 3A. Further, while five feature map processors are shown in the illustrated embodiment, other embodiments may use a greater or lesser number of feature map processors.

Each image input to the feature map processor is analyzed to identify candidate vehicles captured in the image. In layers with lower granularities, large vehicles may be detected. In comparison, in layers with smaller dimensions, smaller vehicles which may only be visible at higher levels of granularity may be detected. In an embodiment, the feature map processor may process a cropped image through multiple, if not all, feature maps in parallel to preserve processing capacity and efficiency. In the exemplary illustrated embodiment, the scale ranges of objects that are detected at each feature layer are 8 to 20, 20 to 32, 32 to 43, 43 to 53, and 53 to 64 pixels, respectively.

For example, the feature map processor processes a 512×512 pixel image at various feature map layers using a filter designed for each layer. A feature map may be generated for each layer using the corresponding filter, shown at 1045 and 1050. In one embodiment, a feature map is a 3-dimensional representation of a captured image and each point on the feature map is a vector of x, y, and z coordinates.

At each feature map layer, the feature map processes each image using two filters: an object classification filter and a regression filter. The object classification filter maps the input into a set of two class probabilities. These two classes are vehicle or background. The object classification filter implements a base computer vision neural network that extracts certain features from each cell of the feature map. Based on the extracted features, the object classification filter outputs a label for the cell as either background or vehicle, shown at 1055 and 1060, respectively. In an embodiment, the object classification filter makes a determination whether the cell is part of a vehicle or not. If the cell is not part of a vehicle, the cell is assigned a background label. Based on the extracted features, a feature value is determined for each cell and, by aggregating feature values from all cells in a feature map, a representative feature value is determined for each feature map. The feature value of each cell of a feature map is organized into a feature vector, characterizing which cells of the feature map are part of the image's background and which cells include vehicles.

Using the feature vector and/or feature value for each cell, the feature map processor implements a regression filter to generate bounding boxes around vehicles in the captured image. The implemented regression filter generates a bounding box around grouped cells labeled as vehicle. Accordingly, a bounding box identifies a vehicle in an image by separating a group of vehicle-labeled cells from surrounding background-labeled cells, shown at 1065 and 1070. The regression filter, which predicts three parameters: two for location (x), and one for the length of a square bounding box around the center, indicated in FIG. 10 as Δcenterₓ, Δcenter_{y}, Δsize. Because of the third parameter, the generated bounding box is a square which allows for more accurate object detection compared to conventional systems which merely implement rectangular bounding boxes based on the two location parameters. In an embodiment, square bounding boxes enable objects in an image to be detected at any orientation, while also aligning parallel to the image boundary (also called “axis aligned” boxes).

As shown generally in FIGS. 8 and 815, Vehicle Classification is performed in a manner similar to vehicle detection. Bounding boxes generated using the regression filter represent vehicles detected in an image and may be provided for display through a user interface on a screen of a computing device (or coupled with a computing device), such as shown at step 140 of FIG. 2. For each detected vehicle, a vehicle classification module may be configured to capture a small image snippet around a center location of the vehicle. Alternatively, a center location of the bounding box may be captured. The vehicle classification module may be configured to input the snippet into a second neural network trained for vehicle classification, hereafter referred to as a vehicle classifier network. The vehicle classifier network outputs class probabilities for each of N predefined classes of vehicle and an “overflow” category labeled “Other Vehicle”. The “Other Vehicle” class may be reserved for vehicles detected by the vehicle detector, different from any of the N predefined classes of vehicle.

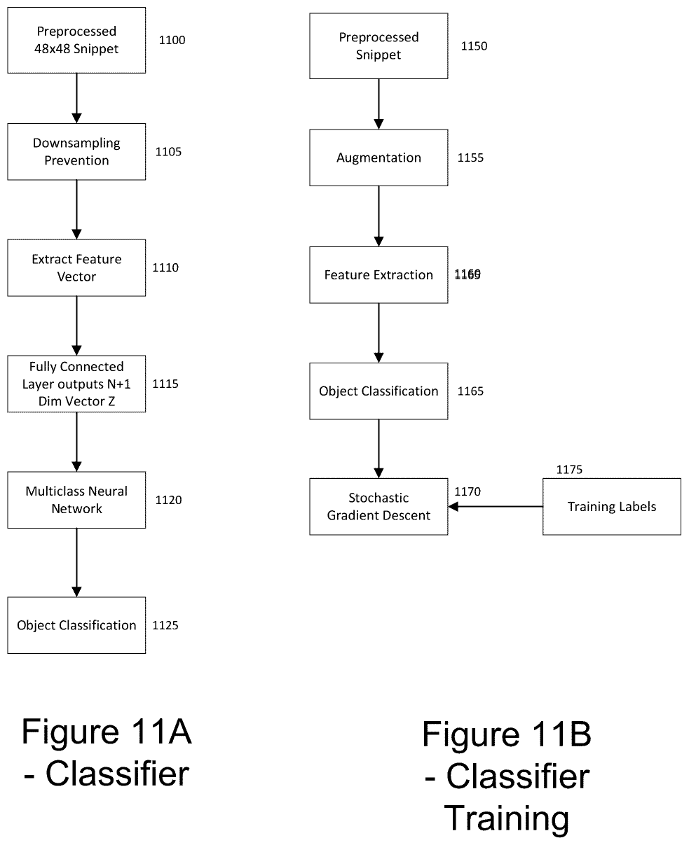

Referring next to FIG. 11A, in an embodiment, the vehicle classifier network may be configured as follows: first, a pre-processed 48×48 pixel image, shown at 1100, is input into feature extractor designed to prevent downsampling of the already small image snippet. In such an embodiment, downsampling prevention, step 1105, can be achieved either by defining a convolution layer of size 7×7 with a stride of 1×1, or removal of a max-pooling layer of size 3×3 with a stride of 2×2. At 1110, the feature extractor extracts a feature vector from the input image snippet. The feature vector serves as an input into a fully connected layer, step 1115, which in turn outputs an N+1 dimensional vector Z. The vector Z is the provided to a multiclass neural network, step 1120, which serves as a vehicle classifier network. In an embodiment, the multiclass neural network is trained such that each class of the vehicle classifier network represents a distinct type of vehicle, such as a sedan, truck, minivan, and so on. The class probabilities for each of the N+1 classes of the multiclass neural network may be calculated as follows using a softmax function, for example the function defined below:

$$p ( {c}_{k} ) = \frac{{e}^{{Z}_{k}}}{{\sum }_{i = 1}^{N + 1} {e}^{{Z}_{i}}}$$

Here, p(cₖ) denotes the probability that the input snippet belongs to the class cₖ, resulting in object classification as shown at step 1125. It will be appreciated that, once object detection and classification is complete, the baseline image has been generated as shown at step 880 in FIG. 8.

Training of the classifier can be understood with reference to FIG. 11B. In one example embodiment, preprocessed snippets form a training data set. At least some images of the data set are augmented, step 1155, by one or more of the following procedures:
1. Each snippet is randomly translated by up to 8 pixels around the center location by translating the full image first and re-cropping from the translated image, so that there are no empty regions in the translated snippet.
2. Each snippet is randomly rotated by angles ranging in (0,2%) by rotating the full image and creating a crop of 48×48 pixels around the vehicle center location.
3. The snippet is further perturbed for contrast and color using one or more deep neural network software frameworks such as TensorFlow, MxNet, and PyTorch. The translated, rotated and perturbed images are then processed in a feature extractor, 1160.
4. The results of the feature extractor are then supplied to an object classification step, 1165. Each classifier may be trained to detect certain classes of interest (COI) with higher accuracy than non-COI classes. In an embodiment, to prevent classifiers from being trained with biases towards classes with larger samples of training data, for example a larger number of training images, the training process may implement a standard cross-entropy-based loss term which assigns a higher weight to certain COI's and penalizes misclassification for specific COI's. In an embodiment, such a loss function is modeled as:

$${Loss}_{combined} = {Loss}_{cross \_ entropy} + {αLoss}_{custom}$$

where Loss_{custom} is a cross-entropy loss function for a binary classifier for a generic COI that penalizes misclassification between the two sets of classes. Loss_{cross_entropy} is a standard cross-entropy loss function with higher weights for COI.

The most accurate model may be selected based on a customized metric that assigns higher weights to classification accuracy of objects belonging to a set of higher interest classes.

In one example embodiment, the network weights are initialized randomly and the weights are optimized through stochastic gradient descent, and the training images are labeled, 1170 and 1175.

In some example embodiments, training data for the vehicle detector and vehicle classifier may be initially gathered manually in a one-time operation. For example, a manual label technique may label all vehicles in a given satellite image. Each vehicle is manually marked with its bounding box, and its type. During training, all vehicles are labeled in each image, regardless of whether a vehicle belongs to one of the N vehicle classes that are of current interest to a user. Vehicles that are not included in any of the N classes may be labeled with type “Other vehicle”, resulting in a total of N+1 classes of vehicle. The data collected from the initial labeling process may be stored to generate a training data set for use (or application) with a machine learning model. In an embodiment, the machine learning model disclosed herein incorporates additional aspects of the configurations, and options, disclosed herein. The computing system of the present invention, when executing the processes described herein, may subsequently execute that machine learning model to identify or suggest labels of such additional vehicle types if identified in later-processed imagery.

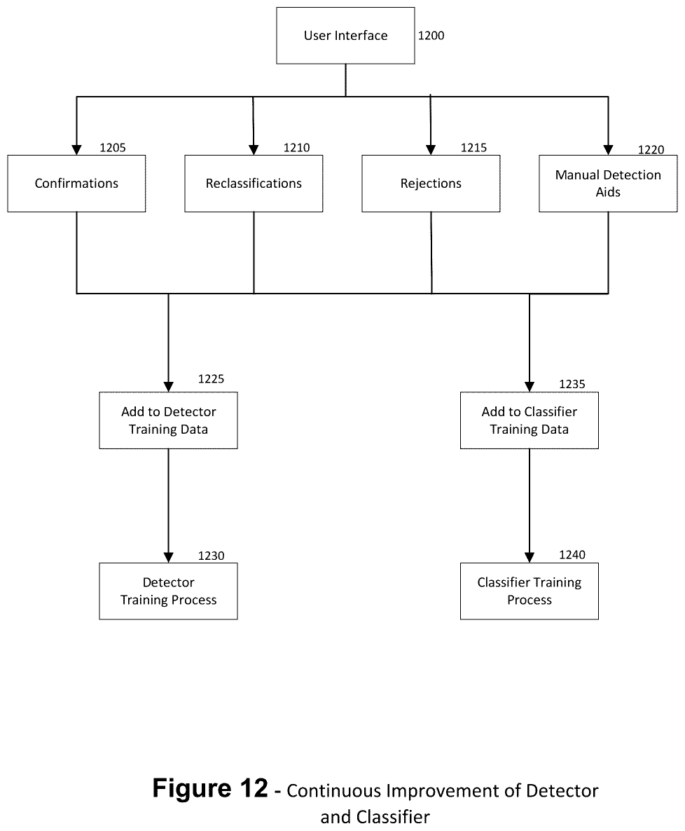

Referring next to FIG. 12, an aspect of the invention directed to ensuring continuous improvement of the detector and classifier processes can be better appreciated. In certain example embodiments, as new imagery is periodically ingested (e.g., electronically retrieved or received) and processed for multi-object detection (again using multi-vehicle detection for convenience) on a regular basis, the vehicle detector may erroneously fail to detect or incorrectly detect a vehicle or its position in an image or the vehicle classifier may incorrectly classify a detected vehicle. For example, the terrain in the new image may be wet or covered in snow while the original training data may not have included any of these variations. In an embodiment, such errors can be corrected manually and used to retrain the detector and/or classifier to increase the accuracy of the vehicle detector and/or classifier over time. In one example embodiment, the MVD is continuously improved for accuracy as follows:

A user interface 1200 may be provided for display on a screen of a computing device (or coupled with a computing device) to enable users to interact with the system to correct errors in generated results. Among other things, the user interface may allow the ingestion of imagery followed by subsequent MVD and the search over any combination of vehicle types, proximity between vehicles of given types, times, and geofences. Using the interface, a user may be able to confirm, reject, or re-classify vehicles detected by the system, shown at 1205-1220. In such instances, the user interface may also allow the user to draw a bounding box over missed vehicles or draw a corrected bounding box to replace an incorrect one. Such confirmations, rejections, re-classifications, and new bounding boxes for missed vehicles, collectively referred to as “correction data”, are stored in a database for future use or training of the model.

In continuously running processes, the vehicle detector process and the vehicle classifier process each receive the correction data, steps 1225 and 1235, respectively, and periodically generate or train new vehicle detector and vehicle classifier models, steps 1230 and 1240. These new models may be trained on the union of the original data and the gathered correction data. The training processes used for the vehicle detector and vehicle classifier are as described above

From the foregoing, it will be appreciated that the two-stage process of vehicle detection followed by vehicle classification of the present invention alleviates the laborious and computationally-intensive process characteristic of the prior art. Without such bifurcation, that laborious process would be needed every time the original set of classes C1 is to be augmented with a new set of classes C2. Because a vehicle detector trained on C1, VD1, is agnostic to vehicle type, it will detect vehicles in C2. However, the original vehicle classifier (VC1), being class specific, and trained on C1, will not have any knowledge of vehicles in C2, and will need to be enhanced, for example by training, to be able to classify vehicles in C1+C2.

As described in above in the section titled Training Data, a user interface allows a user to re-classify the type of a vehicle from class C2, which may have been detected as one of the classes in C1. The continuous vehicle classifier training process described in the section titled Continuous Improvement of MVD causes the correction data from the previous step representing samples from the class C2 to be added to the running training data set. The network architecture for the vehicle classifier may be modified such that the length of the fully connected layer is increased from the original N+1 to N+M+1, where M is the number of classes of vehicle in C2. The new weights corresponding to the added fully connected layer neurons are initialized randomly, and the neural network is trained as described in the foregoing Training section using the updated dataset.

In some implementations, users of the system would like to detect a new class of objects not currently included in the repertoire of classes that the system is already configured to detect and classify. For example, a system may be configured to detect and classify objects in the set [car, bus, truck, other vehicle]. The user now determines that they want the system to detect and classify minivans in addition to the classes in the existing set. In such an instance, in an embodiment the user interface of the system enables the user to define a custom class of objects, in this example “minivan”. Once the new class is defined, the user is invited to provide at least some examples of the newly defined class of objects. In an embodiment, this is accomplished by the user applying bounding boxes or re-classifying existing detections. In some implementations, approximately one hundred such examples as sufficient for the system to begin gathering data, although the number can be significantly lower for systems that incorporate low-shot learning techniques. The samples can be any combination of newly applied bounding boxes or reclassifications. Based on those examples, the system starts gathering training data for the minivan object as the system otherwise performs the detect and classify functions discussed above.

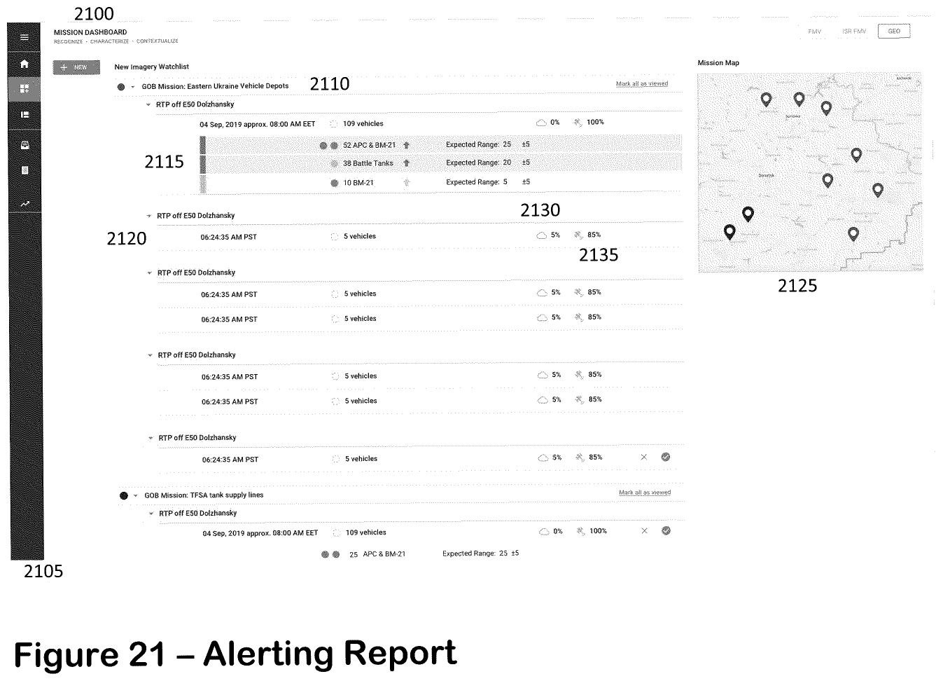

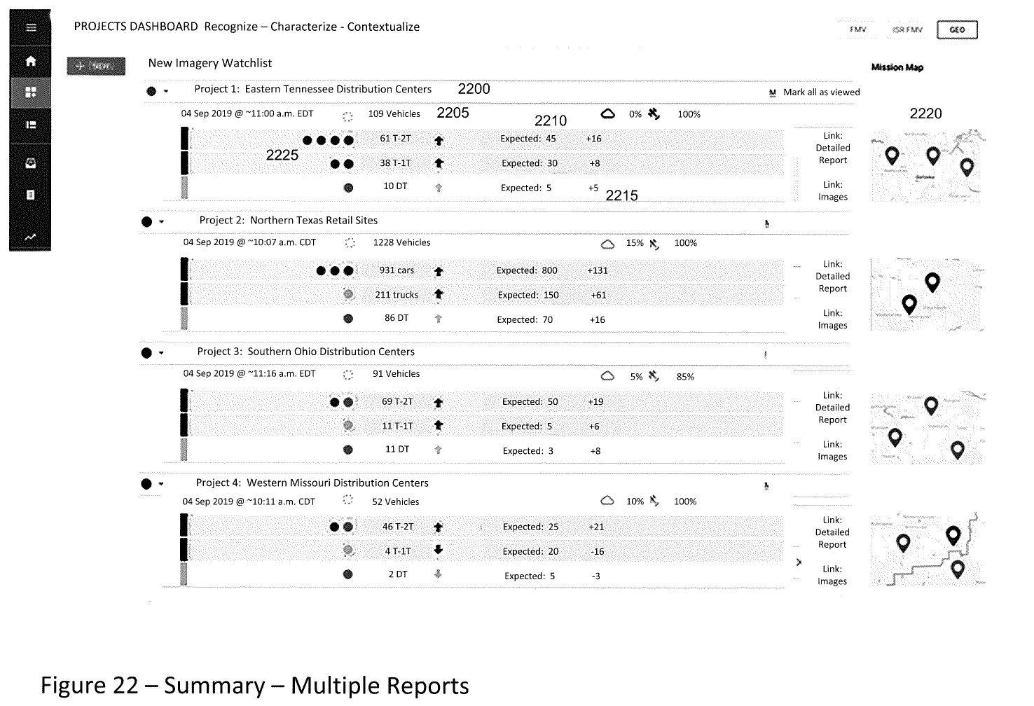

As training for the new object begins, the system may not always correctly detect and identify the new object. Such errors can be either that the system did not detect the minivan at all, or that, while the minivan was detected, the system identified it as something other than a minivan. In either case, the system provides to an operator the opportunity to correct both types of errors by providing hyperlinks in the user interface (discussed in more detail in connection with FIGS. 21 and 22, below) that allow the operator to view, including manually zooming and panning, the images, or maps, that underlay the system-generated results. Thus, the user can manually add bounding boxes around missed objects, or can re-classify mis-classified objects. The new detections and reclassified detections result in new training data samples of the new object, in this example “minivan”, that the system then uses to enhance both the detector and the classifier.

Then, as described above in connection with FIG. 12, the detector of the system is enhanced automatically to detect the new class of object, starting in some embodiments from the very first sample of the new object. As more instances of the object occur, the detector detects the new object with increasing accuracy and reliability.

At that point, the task becomes one of updating the classifier to reliably classify the new object. Continuing with the example of a minivan as the new object, until sufficient training occurs, the system may detect a minivan but then classify it as a car or “other vehicle.” The results are provided to the user by the system, and the user can then re-classify the object into the new class. The system tracks the number of samples of the new class of object. Once the number of samples exceeds a minimum threshold, for example one hundred samples, the system begins training a new classifier for the prior set of objects, plus the new object. The number of samples required to begin training a new classifier can be significantly lower depending upon the learning algorithm, for example in embodiments that use low shot learning. Since the prior set comprised N+1 objects, the addition of the new object means the new classifier is being trained to classify N+2 objects, where the (N+2) th object is the minivan. The new classifier then follows the process discussed above in connection with FIGS. 11A-11B, except that step 1115 now has (N+2) dimensional output rather than the (N+1) dimensional output discussed there.

As noted above in connection with FIGS. 1 through 4B, the user selects a geofenced area at the beginning of the overall process of the present invention. For any given geofence, the foregoing processes create a reference image that defines a baseline state, hereinafter referred to as a “baseline image” for convenience. That baseline image includes bounding boxes around objects of interest, which can be compared to objects detected in future images which include at least a portion of the same geofence. In many instances, the most valuable data is the change in status of any or all of the objects of interest detected and classified in the baseline image.

In many applications of the present invention, new images arrive on a regular basis. In an embodiment, if one of the pre-defined geofences is being monitored, such as those selected at FIG. 4A herein, any new images that cover all or part of a geofence may be compared against the baseline images that comprise the relevant geofenced area. To begin comparison, the baseline image for that geofence is retrieved.

The new image is then processed to achieve registration with the baseline image. The baseline image and the new image are first registered to correct for any global geometric transformation between them over the geofence. This is required because sometimes a given overhead image contains tens to hundreds of meters of geopositioning error, especially satellite imagery. Known techniques such as those discussed in Evangelidis, G. D. and Psarakis, E. Z. (2008), “Parametric image alignment using enhanced correlation coefficient maximization.” IEEE Transactions on Pattern Analysis and Machine Intelligence, 30 (10): 1858-1865 are all that are typically required in the registration step for small geofence sizes on the order of a few hundred square kilometers. Sometimes, especially for large geofences, in addition to a global mismatch in geopositioning, there remains a local distortion due to differences in terrain altitude within the geofence. Such local distortions can be corrected using a digital elevation map, and orthorectification, as described in Zhou, Guoqing, et al. “A Comprehensive Study on Urban True Orthorectification.” IEEE Transactions on Geoscience and Remote Sensing 43.9 (2005): 2138-2147. The end result of the registration step, whether global or (global+local), is a pixel by pixel offset vector from the new image to the baseline image. A digital elevation map (DEM) can also be provided for better accuracy in the registration step.

While satellite imagery can capture relatively small surface details, cloud cover or other atmospheric interference materially impacts the quality of the image and thus the accuracy of any assessment of objects within a geofenced area. For example, if a baseline image shows a quantity of vehicles in a geofence, and the new image shows very few, indicating a large change, it is important to know that the change in detected objects is meaningful and not due to clouds, smoke, ash, smog, or other atmospheric interference. For the sake of simplicity and clarity of disclosure, cloud cover will be used as exemplary in the following discussion.

Cloud detection is challenging as clouds vary significantly from textureless bright white blobs to greyish regions with rounded edges. These regions are difficult to detect based on mere appearance as they could be easily confused with snow cover on the ground or clear bright fields in panchromatic satellite imagery. In an embodiment three cues can prove useful for detecting clouds and other similar atmospheric interference: a) outer edges or contours, b) inner edges or texture, c) appearance. In an embodiment, a shallow neural network (i.e., only a single hidden layer) is trained with features designed to capturing these cues. Classification is performed on a uniform grid of non-overlapping, patches of fixed size 48×48 pixels that was empirically estimated to balance including sufficient context for the classifier to make a decision without sacrificing performance gains.

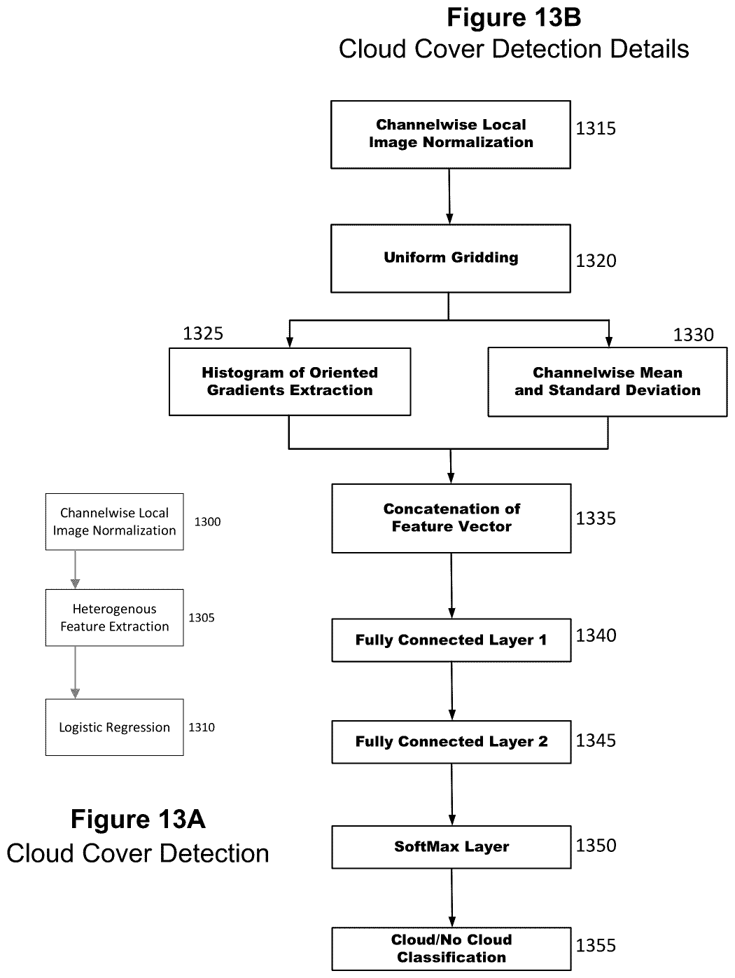

With reference to FIG. 13A, in an embodiment cloud cover detection uses the following inference pipeline: (1) Channel-wise local image normalization, step 1300, (2) Feature extraction, step 1305, (3) Classification via a deep neural network using logistic regression, step 1310.

The process of detecting cloud cover or other atmospheric interference can be appreciated in greater detail from FIG. 13B. Channel-wise local image normalization, step 1315, is helpful to enhance contrast of the images for better edge and contour extraction. Furthermore, normalization helps in training better models for classification by overcoming covariate shift in the data. The input image is normalized by transforming the mean and standard deviation of pixel distribution to \hat{μ}_{R}=\hat{μ}_{G}=\hat{μ}_{B}=127 and \hat{σ}_{R}=\hat{σ}_{G}=\hat{σ}_{B}=25 respectively in an image window of 512×512.

$$( {\hat{R}}_{i} , {\hat{G}}_{i} , {\hat{B}}_{i} ) = ( \frac{{R}_{i} - {μ}_{R}}{{σ}_{R}} \times {\hat{σ}}_{R} + {\hat{μ}}_{R} , \frac{{G}_{i} - {μ}_{G}}{{σ}_{G}} \times {\hat{σ}}_{G} + {\hat{μ}}_{G} , \frac{{B}_{i} - {μ}_{B}}{{σ}_{B}} \times {\hat{σ}}_{B} + {\hat{μ}}_{B} )$$

### Where:

(\hat{R}ᵢ, Ĝᵢ, \hat{B}ᵢ) is the contrast normalized color at a pixel position i.
(μ_{R}, μ_{G}, μ_{B}) are the source means of the red, green, and blue channels in the image.
(σ_{R}, σ_{G}, σ_{B}) are the source standard deviations of the red, green, and blue channels in the image.
(\hat{μ}| |R, \hat{μ}_{G}, \hat{μ}_{B}) are the target means of the red, green, and blue channels in the image.
(\hat{σ}_{R}, \hat{σ}_{G}, \hat{σ}_{B}) are the target standard deviations of the red, green, and blue channels in the image.

Following image normalization, heterogeneous feature extraction is performed using a uniform grid of non-overlapping, patches of fixed size 48×48 pixels, step 1320, as discussed above. Features that are used to train the cloud patch classifier include concatenation of edge-based descriptors to capture edge and contour characteristics of the cloud, and color/intensity-based descriptors that capture appearance of the cloud.

In at least some embodiments, edge-based descriptors can provide helpful additional detail. In an embodiment, HOG (Histogram of Oriented Gradients) descriptors are used to learn interior texture and outer contours of the patch, step 1325. HOG descriptors efficiently model these characteristics as a histogram of gradient orientations that are computed over cells of size 7×7 pixels. Each patch has 6×6 cells and for each cell a histogram of signed gradients with 15 bins is computed. Signed gradients are helpful, and in some embodiments may be critical, as cloud regions typically have bright interiors and dark surrounding regions. The intensity of the cells is normalized over a 2×2 cells block and smoothed using a Gaussian distribution of scale 4.0 to remove noisy edges. The HOG descriptor is computed over a gray scale image patch.

Color-based descriptors are also important in at least some embodiments. Channel-wise mean and standard deviation of intensities across a 48×48 patch can be used as the appearance cue, step 1330. This step is performed after contrast normalization in order to make these statistics more discriminative.

Then, as shown at 1335, feature vectors are concatenated. Fully connected (FC) layers introduce non-linearities in the classification mapping function. The concatenated features are fed into a neural network with three FC layers and ReLU (Rectified Linear Units) activations, steps 1340-1345. In an embodiment, the number of hidden units can be 64 in the first FC layer, 32 in the second FC layer, and 2 in the top most FC layer, which, after passing it through the softmax function, 1350, is used for making the cloud/no cloud decision, 1355. The network has simple structure and built bottom up to have minimal weights without sacrificing learning capacity. Using these techniques, model size can be kept very low, for example ˜150 KB.

In an embodiment, the weights corresponding to the hidden FC layer can be trained by randomly sampling 512×512 chips from the geotiffs. Each training geotiff has a cloud cover labeled as a low-resolution image mask. For training, labeled patches are extracted from this normalized 512×512 chip such that the positive to negative ratio does not drop below 1:5. Training is very fast as the feature extraction is not learned during the training process.

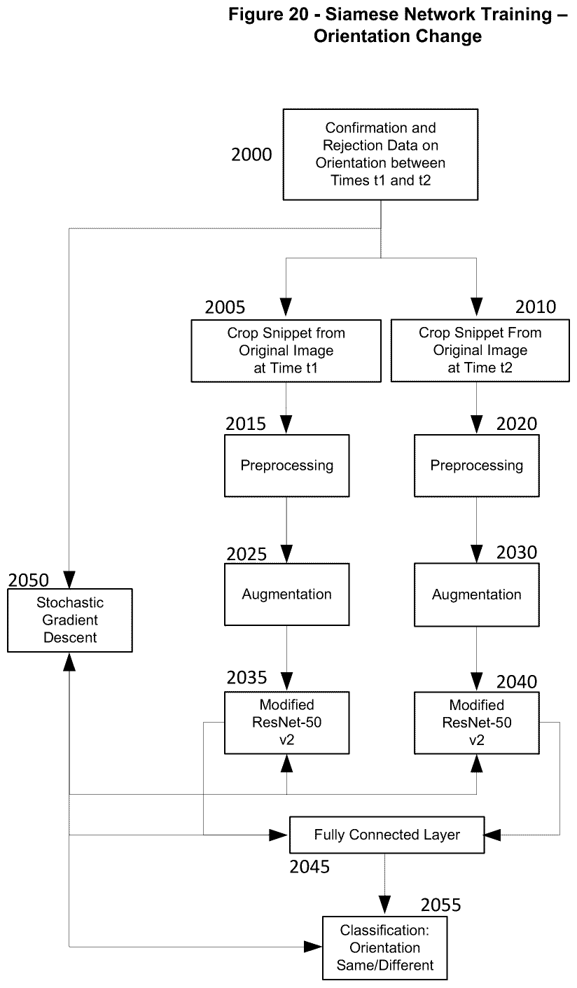

Given a geofence and the cloud cover detection result, we calculate the area of the geofence covered by clouds. To assist the user, the percentage of the monitored area covered by clouds is reported as discussed hereinafter in connection with FIGS. 20 and 21.

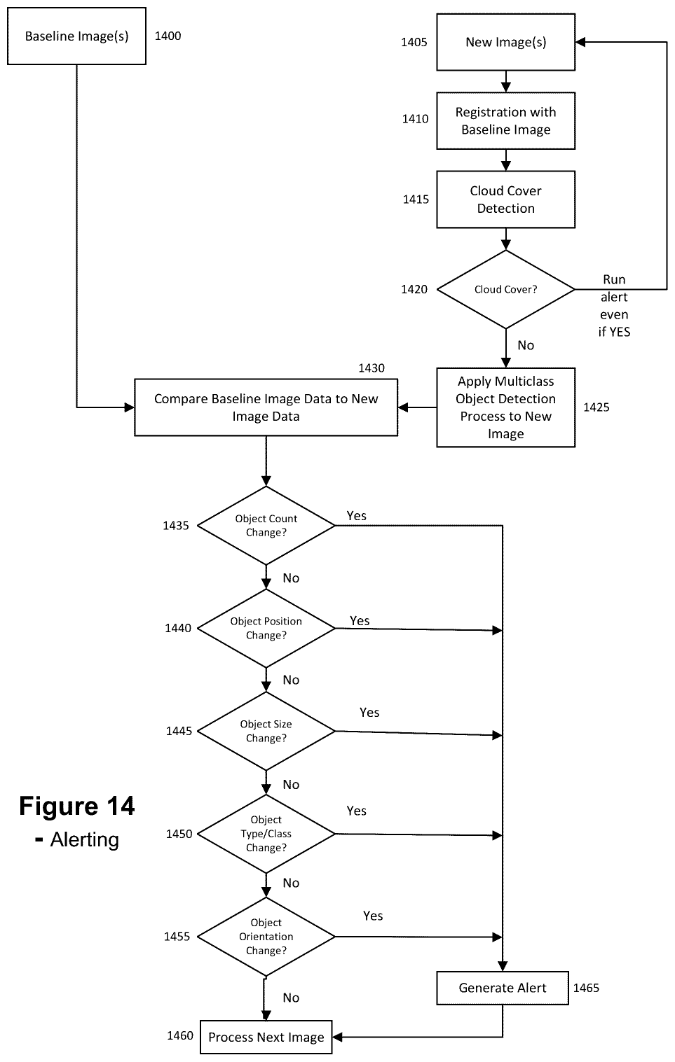

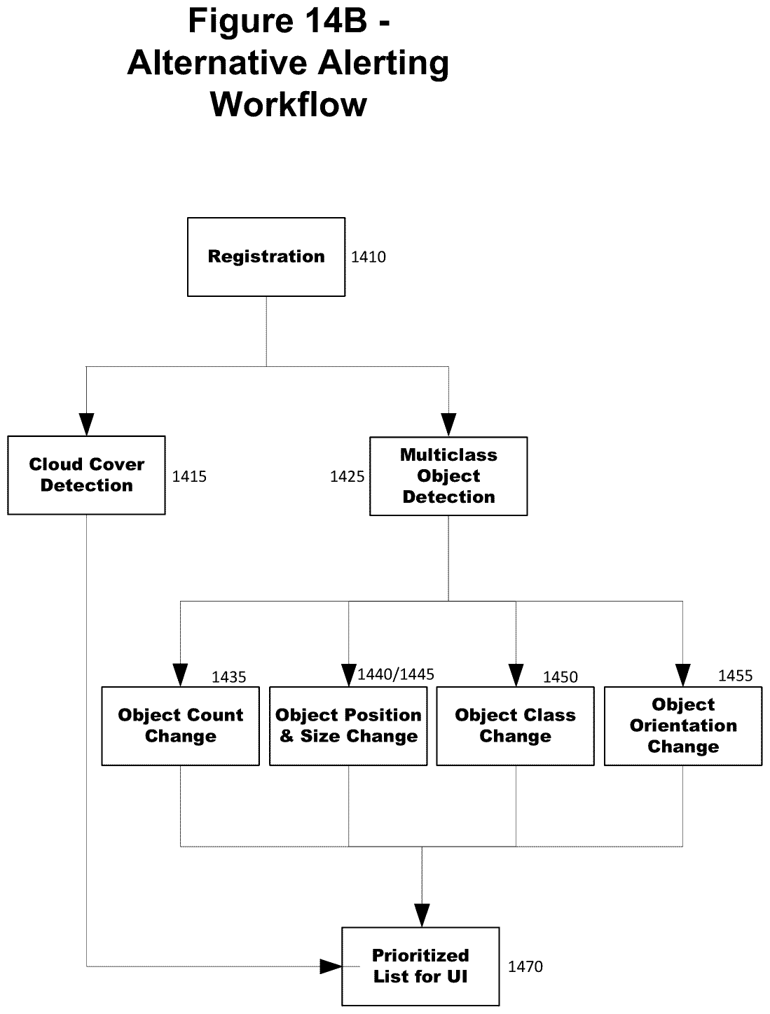

As discussed above in connection with FIGS. 6A-12, and discussed at length in U.S. Patent Application Ser. No. 62/962,928 filed Jan. 17, 2020, incorporated herein by reference in full, detecting multiple classes of vehicle in overhead imagery is in itself a challenging task. As discussed in the '928 application and hereinabove, the multiclass object detector returns a set of objects Oᵢ, i=1 . . . N, where each object Oᵢ is a tuple: (X_{c}ⁱ,Y_{c}ⁱ,Hⁱ,\vec{C}ⁱ) where (X_{c}ⁱ,Y_{c}ⁱ) is the center of the i^{th} object, Wⁱ is its width, Hⁱ is its height, and \vec{C}ⁱ is a vector of class probabilities for the object. These same techniques are used to process the new image, such that a comparison can be made between objects of interest in the baseline image and objects of interest in the new image. Thanks to the registration step above, we now have two images that are spatially aligned. The next step is to determine the significance of change, shown generally in process flow diagrams FIGS. 14A-14B, which show slight alternatives for an alerting process in accordance with embodiments of the invention. For clarity, like steps are shown with like reference numerals. In an embodiment, the comparison process detects a stratified list of changes: (1) Object count changes, (2) Object position and size changes, (3) Object type changes, and (4) Object orientation changes. As shown in FIGS. 14A-14B, a baseline image, or one of a series of images, is provided at 1400. Similarly, a new image is provided at 1405, and registration of the new image with the baseline image is performed at 1410, followed by cloud cover detection at 1415. If cloud cover or other atmospheric interference is detected at 1420 as occluding too much of an image to yield meaningful results, the process may loop back to a next image. If the cloud cover is below a threshold such that meaningful analysis can be performed, the process advances to multiclass object detection, step 1425. In other embodiments, multiclass object detection is performed even where cloud cover exceeds a threshold, since in some cases the only available images all have data occlusion due to cloud cover or other atmospheric interference. At step 1430, the baseline image data set and the new image data set are prepared for comparison.

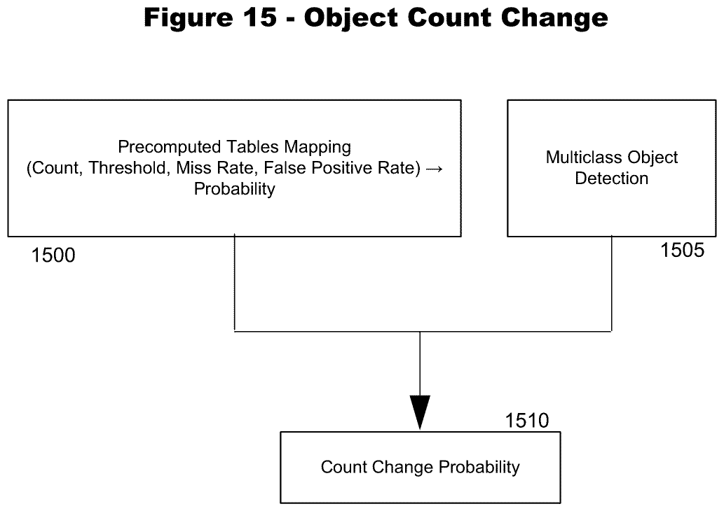

Next, at step 1430, object count changes are detected. The task of this module is to determine if there is a significant change in the observed counts of a particular object type in a given geofence, and is described in greater detail in connection with FIG. 15. The foundation for this module is the output of the multiclass object detector described above. Computer vision-based object detectors are not perfect, and typically have a miss detection rate and a false positive rate. These are statistical quantities that vary from image to image. Despite these limitations, the question to be answered is: Given the miss detection rate, false positive rate, and their statistical distributions, what can be said about the probability that the change in actual count of vehicles in a geofence exceeds a threshold, based on a comparison of the baseline data set and new image data set. In an embodiment, and as a first approximation, assume that the miss detection rate and false positive rate follow a normal distribution. The mean and standard deviations can be obtained empirically via training data, or by manual inspection over a sample of images.

Note that miss rate is defined over the actual vehicle count, and false positive rate is defined over the observed vehicle count, as is standard practice. So, given the true vehicle count X, there will be m missed vehicles where:

\hat{m}=X [symbol] (μₘ,σₘ)
Given the observed vehicle count \hat{X} there will be f false positive vehicles where:

\hat{f}=\hat{X} [symbol] (μ_{f},σ_{f})
Therefore we can write:

$$\hat{X} = X - X 𝒩 ( {μ}_{m} , {σ}_{m} ) + \hat{X} 𝒩 ( {μ}_{f} , {σ}_{f} )$$

Given the observed vehicle count \hat{X}, an estimate for the true count is therefore:

$$X = \hat{X} ( \frac{1 - 𝒩 ( {μ}_{f} , {σ}_{f} )}{1 - 𝒩 ( {μ}_{m} , {σ}_{m} )} )$$

Given an observation \hat{X}=k: the probability that the original count X is greater than or equal to a threshold T is given by:

$$P ( X \geq T ) = {\int }_{x = T}^{∞} P ( x \vert \hat{X} = k ) dx$$

In an embodiment, the probabilities for various observed vehicle count thresholds & and thresholds T are precomputed and their probabilities stored in a look-up table (LUT), 1500. At run-time, in evaluating the data set from the multiclass object detection step 1505, the applicable probability, given the observation count and threshold, is retrieved from the LUT and a count change probability is generated, 1510. The user can configure a probability threshold, for example 95%, at which to raise an alert. The determination on whether the count has fallen below a threshold T is performed in a similar manner, except that the integral is from zero to T. If the object count change is significant as determined above, an alert is raised at 1465, and a human analyst reviews the alert

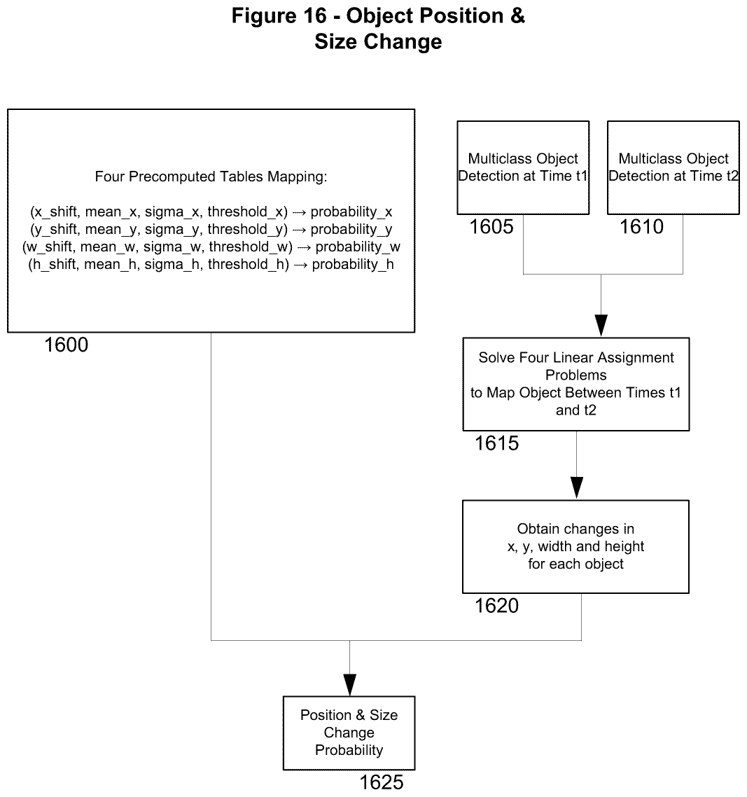

Even if object counts have not changed, there is a possibility that objects may have moved from their original position or are different size, shown at 1440 and 1445 in FIGS. 14A-14B. This requires mapping of the objects detected between two times t₁ and t₂, step 1600 This is done by setting up a linear assignment problem between the objects detected at the two times, which process can be appreciated in greater detail with reference to FIG. 16. A matrix of mapping costs is constructed as follows:
where:

$${c}_{ij} = {λ}_{1} \vert {X}_{c}^{i} - {X}_{c}^{j} \vert + {λ}_{2} \vert {Y}_{c}^{i} - {Y}_{c}^{j} \vert + {λ}_{3} \vert {W}^{i} - {W}^{j} \vert + {λ}_{4} \vert {H}^{i} - {H}^{j} \vert$$

and λᵢ are the weights associated with the difference in positions and dimensions of the ith object at time t₁ and ith object at time t₂, steps 1605 and 1610.

As is standard practice for setting up linear assignment problems, if there are unequal numbers of boxes between the two times, “dummy” rows or columns of zeros are added to the time containing fewer boxes, so that the matrix C is a square. The task now is to determine which mapping of object boxes between the two times results incurs the smallest cost. This linear assignment problem, 1615, can be solved using standard algorithms such as those discussed in Munkres, James. “Algorithms for the assignment and transportation problems.” Journal of the Society for Industrial and Applied Mathematics 5.1 (1957): 32-38, and Jonker, Roy, and Anton Volgenant, “A shortest augmenting path algorithm for dense and sparse linear assignment problems.” Computing 38.4 (1987): 325-340. Once this is done, we have a set of mapped object bounding boxes between time t₁ and t₂.

C=[cᵢⱼ]

where:

$${c}_{ij} = {λ}_{1} \vert {X}_{c}^{i} - {X}_{c}^{j} \vert + {λ}_{2} \vert {Y}_{c}^{i} - {Y}_{c}^{j} \vert + {λ}_{3} \vert {W}^{i} - {W}^{j} \vert + {λ}_{4} \vert {H}^{i} - {H}^{j} \vert$$

If an object goes missing or appears anew, the linear assignment problem solution will map it to a dummy row/column, and an appropriate alert can be raised.

The task now is to determine if the difference in positions and sizes between two mapped boxes is statistically significant, step 1615. Note that the reported position and sizes of the objects have a certain bias and variance that is characteristic of the multiclass object detector. These can be estimated a priori over training data. As a starting point, in an embodiment it is assumed that any errors in positions and sizes are normally distributed, and that the covariance matrix of the errors is diagonal. Given the positions and sizes of two boxes that have been associated together across time, we want to know if the positions and sizes are significantly different. Normal error distribution for all four values is assumed. Dropping the superscript i for readability yields:

$${\hat{X}}_{c} = {X}_{c} + 𝒩 ( {μ}_{x} , {σ}_{x} ) \\ {\hat{Y}}_{c} = {Y}_{c} + 𝒩 ( {μ}_{y} , {σ}_{y} ) \\ \hat{W} = W + 𝒩 ( {μ}_{W} , {σ}_{W} ) \\ \hat{H} = H + 𝒩 ( {μ}_{H} , {σ}_{H} )$$

Considering only the x coordinate for the purposes of exposition, the difference between two observations of the same box is a normally distributed variable and has twice the standard deviation of the original x coordinate:

$${\hat{δ}}_{{X}_{c}} = {δ}_{{X}_{c}} + 𝒩 ( 0 , 2 {σ}_{x} )$$

where \hat{δ}_{X}_{_{c}}, is the observed difference and δ_{X}_{_{c}}, is the true difference.

$${δ}_{{X}_{c}} = {\hat{δ}}_{{X}_{c}} - 𝒩 ( 0 , 2 {σ}_{x} ) = 𝒩 ( {\hat{δ}}_{{X}_{c}} , 2 {σ}_{x} )$$

The objective is to determine if the absolute values of the difference is above a threshold T, step 1620. Therefore, what is wanted is:

|δ_{X}_{_{c}}|≥T

where |δ_{X}_{_{c}}| is a folded normal distribution (see Tsagris, Michail, Christina Beneki, and Hossein Hassani. “On the folded normal distribution.” Mathematics 2.1 (2014): 12-28) obeying:

$$p ( x \vert {\hat{δ}}_{{X}_{c}} ) = \sqrt{\frac{2}{{πσ}^{2}}} {e}^{- \frac{{( {x}^{2} + {\hat{δ}}_{{X}_{c}}^{2} )}^{2}}{2 {σ}^{2}}} cosh ( \frac{x {\hat{δ}}_{{X}_{c}}}{{σ}^{2}} )$$

Given the observed difference \hat{δ}_{X}_{_{c}}, the alerting rule is:

$$P ( {δ}_{{X}_{c}} >= T \vert {\hat{δ}}_{{X}_{c}} ) = {\int }_{x = T}^{∞} p ( x \vert {\hat{δ}}_{{X}_{c}} ) dx$$

Using the folded normal cumulative distribution formula the definite integral above reduces to the rule:

$$P ( {δ}_{{X}_{c}} >= T \vert {\hat{δ}}_{{X}_{c}} ) = 1 - \frac{1}{2} [ erf ( \frac{T - {\hat{δ}}_{{X}_{c}}}{\sqrt{2 {σ}^{2}}} ) + erf ( \frac{T + {\hat{δ}}_{{X}_{c}}}{\sqrt{2 {σ}^{2}}} ) ]$$

where erf(x) is the error function defined as:

$$erf ( x ) = \frac{2}{\sqrt{π}} {\int }_{0}^{x} {e}^{- {t}^{2}} dt$$

As with vehicle count, the probabilities can be pre-calculated and stored in a LUT, indexed by the observed position shift, and threshold. At run time the probability is retrieved from the LUT given the observed position shift and threshold. If the probability is more than a user-defined amount, an alert is raised as shown at 1465. It will be appreciated that the foregoing analysis was for X_{c}. In an embodiment, a similar analysis is performed for each of Y_{c}, W, and H, and an alert generated if their change probability meets a user-defined threshold as indicated at 1625.

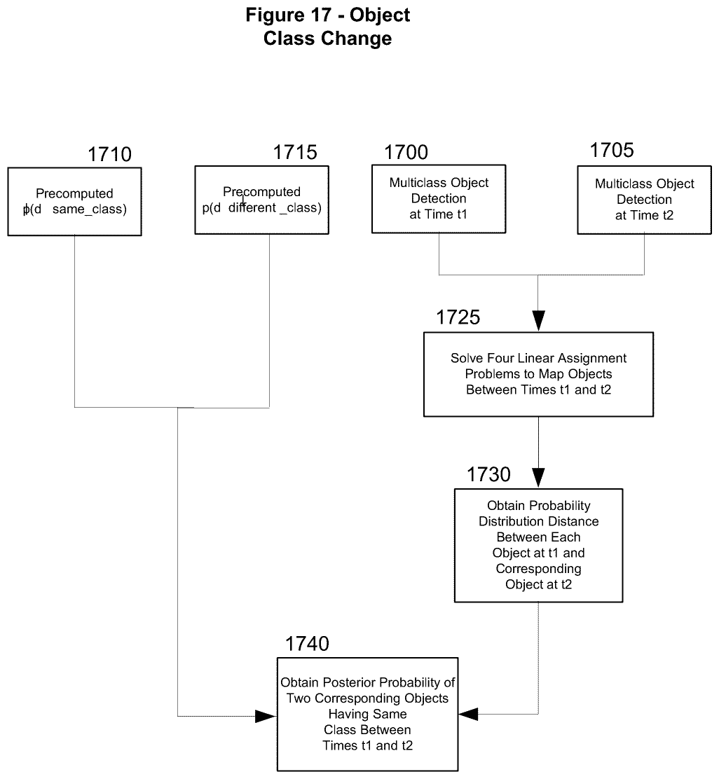

It is also possible that object type or class has changed between the baseline image and the new image, and such changes are detected at 1450 in FIGS. 14A-14B and described in greater detail in FIG. 17. As discussed above, the multiclass object detector returns, for each object, a probability distribution over classes for the object, 1700, 1705 Therefore for the ith object at time t₁ and ith object at time t₂, their respective class probabilities are \vec{C}ⁱ and \vec{C}^{j}. Given this, any probability distance metric can be used for comparing the two probability distributions such as the Kullback Leibler distance, Bhattacharyya distance, cross-entropy distance, etc., step 1725. In an embodiment, the distance between the class probabilities is converted into a probability by estimating, from the multiclass object detector validation dataset, the within class and between class probability distributions for the distance. As shown at 1710 and 1715, these are respectively P (d|same_class) and P(d|different_class) where d is the distance between two instances of an object, and are stored as histograms. Coming back to calculating the probability that the ith object at time t₁ and jth object at time t₂ are the same, step 1730, given their observed distance d(\vec{C}ⁱ, \vec{C}ⁱ) Bayes' rule can be used as follows:

Let dᵢⱼ=d(\vec{C}ⁱ,\vec{C}^{j})

then

$$P ( same \vert {d}_{ij} ) = \frac{P ( {d}_{ij} \vert same ) P ( same )}{P ( {d}_{ij} \vert same ) P ( same ) + P ( {d}_{ij} \vert not\_same ) P ( not\_same )}$$

Note that the conditional probabilities have been estimated via the validation dataset. The prior probabilities can be set as one-half in the absence of any a priori knowledge of whether or not the objects are of the same type. Once again, if the probability that the two objects are not the same is higher than a user configured threshold, an alert is generated at 1435.

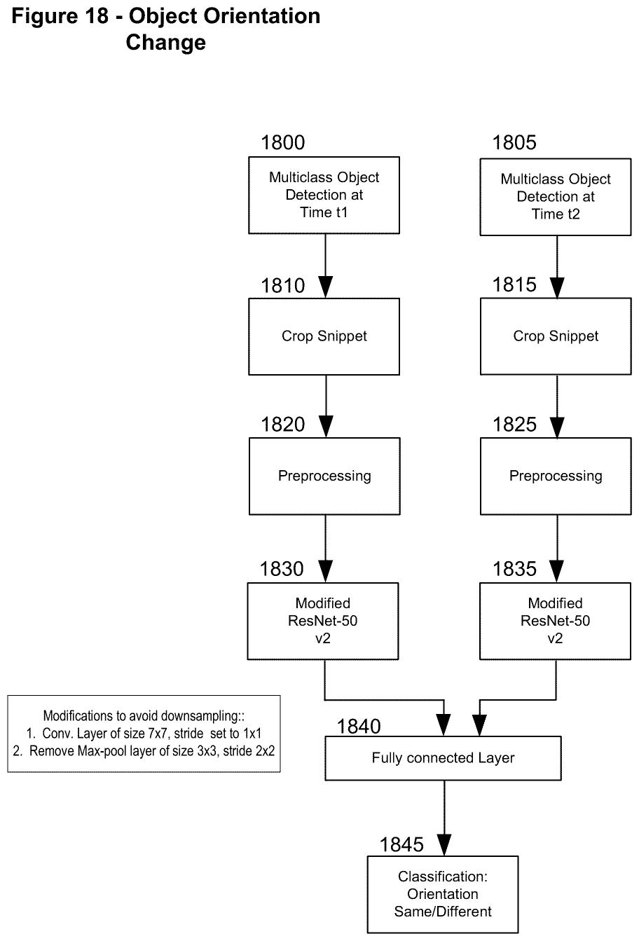

If an alert for a particular location within a geofence has not resulted from the checks made at steps 1435-1450, this implies either that no new object has been found at that location, or that an object previously present there has not moved and continues to be of the same type. A final condition remains to be checked, which is whether the orientation of any objects has changed beyond a threshold amount. Note that a significant orientation change will result in its bounding box size change, which is triggered using the process described above for object position and size change. Therefore the orientation change that needs to be detected now is a multiple of 90º. In order to determine this, again consider the two objects: the ith object at time t₁ and jth object at time t₂. As discussed in greater detail below with reference to FIGS. 18-20, a 48×48 snippet of the original images with the objects is preprocessed and then taken as input into a Siamese neural network that produces as output a score on whether the two snippets are the same or different. The process uses the same base network as the classifier used in the multiclass object detector.

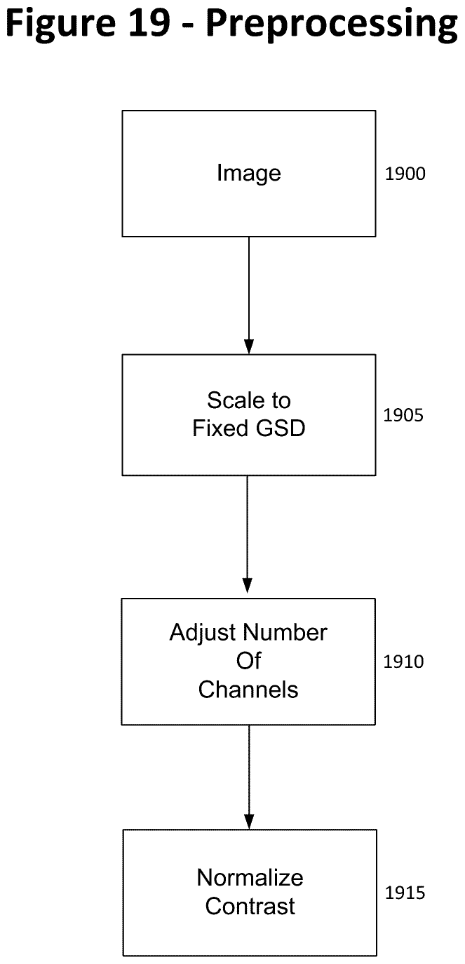

With reference first to FIG. 18, the results of the multiclass object detector at time t₁ and t₂ are provided, indicated at 1800/1805. Each image is then cropped to a 48×48 snippet, steps 1810/1815. With reference to FIG. 19, the 48×48 snippets are pre-processed, steps 1820/1825 to improve resolution and clarity before being input to the object classifier: First, the new image 1900 is scaled horizontally and vertically such that the ground sampling distance (GSD) equals a standard, defined measurement (e.g., 0.3 meters per pixel), step 1905. For example, if the original image GSD is different than 0.3 m/pixel, scaling ensures that the image is brought to 0.3 m/pixel. (2) The number of channels for the image may be adjusted to only include Red, Green, and Blue, 1910. If the image is panchromatic, the images channels are replicated three times to create three channels. (3) Using the three channels, the contrast of the image is normalized, step 1915, based on the below equation. The normalized contrast of image increases the color range of each pixel and improves the contrast measurement.

$$( {\hat{R}}_{i} , {\hat{G}}_{i} , {\hat{B}}_{i} ) = ( \frac{{R}_{i} - {μ}_{R}}{{σ}_{R}} , \frac{{G}_{i} - {μ}_{G}}{{σ}_{G}} , \frac{{B}_{i} - {μ}_{B}}{{σ}_{B}} )$$

### Where:

(\hat{R}ᵢ, Ĝᵢ, \hat{B}ᵢ) is the contrast normalized color at a pixel position I;
(μ_{R}, μ_{G}, μ_{B}) are the means of the red, green, and blue channels in the image;
(σ_{R}, σ_{G}, σ_{B}) are the standard deviations of the red, green, and blue channels in the image.

Again referring to FIG. 18, after the normalizing contrast step of FIG. 19 is completed, the pre-processed images are input to their respective deep neural networks, 1830/1835. The stages of each of the networks are as follows: The pre-processed 48×48 image is input into a feature extractor such as the Resnet-50 v2, step as described in He, Kaiming, et al. “Identity mappings in deep residual networks.” European Conference on Computer Vision. Springer, Cham, 2016, with the following modifications:
a. The convolution layer of size 7×7 has a stride of 1×1 instead of 2×2, to avoid downsampling the already small image snippet
b. The max-pooling layer of size 3×3 and stride of 2×2 was removed, again to avoid downsampling the already small image snippet.

The results from the feature extractors from the two copies of the Siamese network are input into a fully connected layer, step 1840, that outputs a scalar value that is expected to be 1 if the objects have different orientation and 0 if not, step 1845.

With reference next to FIG. 20, in an embodiment, training of the Siamese Neural network uses the cross-entropy loss function between ground truth and the output of the neural network.

Training data for this task is obtained via the user confirming and rejecting pairs of images showing the same or different objects between times t1 and t2, step 2000. The images are cropped as with FIG. 18, steps 2005/2010. The snippets are preprocessed, 2015/2020, as described in connection with FIG. 19. Over time, the system will accumulate sufficient training data to feed the training process. The training data set is augmented, 2025/2030, by perturbing the snippets for contrast and color in a manner offered in various deep neural network software frameworks such as TensorFlow, MxNet, and PyTorch and then passed through modified ResNet-50 v2 neural networks, 2035/2040 and a fully connected layer 2045 as discussed above in connection with FIG. 18. The network weights are initialized randomly and the weights are optimized through stochastic gradient descent, 2050, as described in Bottou, Leon. “Large-scale machine learning with stochastic gradient descent.” Proceedings of COMPSTAT′2010. Physica-Verlag HD, 2010. 177-186.

Referring next to FIG. 21, an embodiment of an alerting report such as might be generated by the system of the invention can be better appreciated. In general, the user interface presents to the user regions shows changes in object count, position, size, class or type, or orientation that exceed a threshold. More specifically, the dashboard 2100 provides to the user at 2110 a display of the mission or project being monitored. Further, at 2115, the changes that exceed the threshold are identified. In some embodiments, the changes are presented in decreasing order of probability as reported by the process described generally in connection with FIGS. 14A-14B. This allows the user to react more quickly to regions that have the highest probability of change. It also allows them to understand at a quick glance what areas are undergoing significant changes. However, it will be appreciated that, in some embodiments and applications, the particular order can vary with the type of data being monitored and the needs of the user. Further detail about each type of change is indicated at 2120, and a map showing the areas of interest can be displayed at 2125. The areas 2115, 2120 and 2125 can each include hyperlinks to permit the user to access quickly the underlying data, including images, that led to the alerts. In an embodiment, the user is brought to a zoomable and pannable version of the image and, as desired, is permitted either to identify any missed objects by manually adding a bounding box to each such object or to reclassify a detected object. Further, the user interface also shows at 2130 the cloud cover percentage over a geofence and, at 2135 the amount of overlap present between a given overhead image and the geofence. These data points allow the user to understand quickly that the quality of the data may explain large changes in object counts or appearance, for example if clouds obscure the geofence, or if the new image does not fully cover the geofence.

Referring next to FIG. 22, the system can also generate at the user interface a higher level of user report, where multiple projects are summarized. Such a report can be useful to higher level decision-makers who need to understand at a glance changes in status across multiple geofences. Thus, for example, FIG. 22 illustrates monitoring four different projects. Three projects involve monitoring of vehicular traffic at different Distribution Centers such as run by large business-to-consumer entities such as Amazon, Walmart, Costco, HomeDepot, Lowes, and so on. The fourth project collectively monitors a group of retail sites, for example the vehicular traffic at a group of retail stores.

For the distribution center projects, the types of vehicles may include tractors with two trailers (T-2T), tractors with a single trailer (T-1T), or delivery trucks (DT), while other types of vehicles are of less or minimal relevance. In contrast, for retail sites, the vehicles of interest might be cars, trucks such as pickups, and delivery trucks, to capture both retail/buyer activity and supply side data such as how often or how many delivery trucks arrive at a retail location.

Data such as this can be very useful to corporate traffic managers, chief marketing officers, and others in the distribution and sales chains of large corporate entities where current information regarding corporate shipping and distribution provides actionable intelligence. Thus, at 2200, project 1 is “Eastern Tennessee Distribution Centers” and the quantities of large trucks of various types are monitored. Current counts are provided at 2205, while expected numbers, typically based on historical or empirical data, are shown at 2210. The difference is shown at 2215 and can indicate either positive or negative change. As with FIG. 21, cloud cover and image coverage are indicated. In addition, maps of each geofence are displayed at 2220. In an embodiment, links to underlying data are provided at the points of interest 2225 on the maps, and or at the data shown at any of elements 2200, 2205, 2210, 2215 or 2220. The level of urgency can be indicated at 2225, using either multiple dots, as shown, where, for example, four dots may indicate an extremely urgent alert while one dot indicates a less significant alert. Alternatively, the significance of an alert can be indicated using different colors, which is preferred in at least some embodiments, or different icons, or any other suitable indicia that the user recognizes as distinguishing alert levels.

From the foregoing, those skilled in the art will recognize that new and novel devices, systems and methods for identifying and classifying objects, including multiple classes of objects, have been disclosed, together with techniques, systems and methods for alerting a user to changes in the detected objects and a user interface that permits a user to rapidly understand the data presented while providing the ability to easily and quickly obtain more granular supporting data. Given the teachings herein, those skilled in the art will recognize numerous alternatives and equivalents that do not vary from the invention, and therefore the present invention is not to be limited by the foregoing description, but only by the appended claims.

We claim:

1. A method for classifying vehicles in an image comprising:
receiving in a computer a current image of a geographic region captured by a satellite, the image comprising one or more objects in an area of interest;
preprocessing at least the area of interest, the preprocessing comprising at least normalizing contrast and scaling the area of interest to a predetermined size,
detecting at least some of the objects and enclosing at least some of the detected objects within a bounding box,
identifying by means of a neural network at least some of the detected objects with their respective bounding boxes,
classifying by means of a neural network at least some of the identified objects in accordance with a library of objects,
for the identified and classified objects, compiling data for the area of interest comprising at least some of a group of factors comprising the count of each class of object, the orientation of object within a class of object, the position of each object within a class, the size of each object within a class,
comparing at least some of the group of factors for objects in the area of interest with those factors compiled for a baseline image for the area of interest and generating an alert if one or more of the comparisons exceeds a predetermined threshold.

2. The method of claim 1 further comprising displaying to a user results of the comparing step that exceed the threshold and including an indicia representative of the significance of the change between the current image and the baseline image.

3. The method of claim 1 wherein the objects are vehicles.

4. The method of claim 1 wherein the detecting step comprises a feature extractor having different levels of granularity.

5. The method of claim 1 wherein the images are satellite images.

6. The method of claim 2 further comprising the steps of detecting and compensating for cloud cover.

7. The method of claim 1 further including determining a confidence value for at least one of the detecting step, the identifying step, and the classifying step.
